(19) United States
(12) Patent Application Publication
(10) Pub. No.: US 2026/0168722 A1
(43) Pub. Date: Jun. 18, 2026

(54) REFRIGERATOR

(71) Applicant: LG ELECTRONICS INC., Seoul (KR)

(72) Inventors: Seongwon GWON, Seoul (KR); Jinho CHANG, Seoul (KR)

(21) Appl. No.: 19/410,100

(22) Filed: Dec. 5, 2025

(30) Foreign Application Priority Data
Dec. 16, 2024 (KR) 10-2024-0187590

(51) Int. Cl. F25D 23/02; E05F 15/619

(52) U.S. Cl. CPC F25D 23/028; E05F 15/619; E05Y 2201/46; E05Y 2900/31; F25D 2323/023; F25D 2323/024

(57) ABSTRACT

Provided is a refrigerator. The refrigerator includes a first door opening and closing a storage chamber of a cabinet and a second door coupled to be rotatable relative to the first door by a second hinge. The second hinge includes a locking hook mounted to be reciprocally movable along a hinge coupling portion by an operation of a door opening and closing device, to be locked to engage with an engaging protrusion of the first door or unlocked from the engaging protrusion when the second door is open or closed. Through this, the locking hook can be automatically locked to or unlocked from the engaging protrusion by an operation of the door opening and closing device.

### CROSS-REFERENCE TO RELATED APPLICATION

Pursuant to 35 U.S.C. § 119(a), this application claims the benefit of the earlier filing date and the right of priority to Korean Patent Application No. 10-2024-0187590, filed on Dec. 16, 2024, the contents of which are incorporated by reference herein in their entirety.

### BACKGROUND

### 1. Field

The disclosure relates to a refrigerator.

### 2. Description of the Related Art

Typically, a refrigerator may include a cabinet having a storage chamber and a door for opening and closing the storage chamber.

The storage chamber is surrounded by insulating walls, so that the inside thereof is kept at a lower temperature than external temperature. Depending on the temperature range of the storage chamber, the storage chamber may be divided into a refrigerating chamber and a freezing chamber.

To put an object into or take it out of the storage chamber, a user opens the door.

In general, the door is rotatably arranged on a cabinet, and a gasket is provided between the door and the cabinet. Therefore, when the door is closed, the gasket seals between the door and the cabinet, suppressing cool air from leaking from the storage chamber. As the sealing force of the gasket increases, the effect of suppressing cool air leakage can increase.

To increase the sealing force of the gasket, the gasket may be formed of a rubber magnet, and a magnet may be arranged inside the gasket.

However, as the sealing force of the gasket increases, a greater force is required to open the door.

Therefore, recently, refrigerators with an automatic door opening function have been provided.

A refrigerator is disclosed in Korean Patent Publication No. 10-2018-0119027, as a prior art document.

The prior art refrigerator includes a cabinet having at least one storage chamber inside, a door arranged on one side of the cabinet to open and close the storage chamber, and a door opening device that moves the door to open the storage chamber by a driving force of a motor.

Specifically, the door may include an inner door arranged in close contact with a front surface of the cabinet, and an outer door positioned on a front surface of the inner door.

The door opening device is positioned on the cabinet, and opens the inner door by pushing the inner door.

However, in the case of the prior art document, when the inner door is open, the outer door is open together with the inner door, so there is a disadvantage in that the outer door cannot be open automatically.

In the case of the prior art document, the door opening device is arranged on the cabinet, and when the outer door is to be open using the door opening device, there is a disadvantage in that the length of the door opening device increases and the structure becomes complicated to push the outer door without interfering with the inner door.

### SUMMARY

The disclosure is directed to providing a refrigerator with a structure which is capable of solving those problems and other drawbacks.

A first aspect is to provide a refrigerator having a structure which is capable of automatically opening a second door, which is located outside in a door-in-door structure including a first door and the second door.

A second aspect is to provide a refrigerator having a structure which is capable of opening a second door automatically or manually.

A third aspect is to provide a refrigerator having a structure which is capable of maintaining a coupled state between a first door and a second door when the first door is open.

A fourth aspect is to provide a refrigerator having a structure which is capable of automatically closing a second door at a reference angle or less.

A fifth aspect is to provide a refrigerator having a structure which is capable of opening a second door (outer door) without interfering with a first door (inner door).

A sixth aspect is to provide a refrigerator having a structure which is capable of automatically opening and closing a door in a non-contact manner.

A seventh aspect is to provide a refrigerator having a structure which is capable of automatically unlocking a first door and a second door.

An eighth aspect is to provide a refrigerator having a structure which is capable of structurally and reliably performing auto-closing of a first door and a second door.

A ninth aspect is to provide a refrigerator having a structure which is capable of reducing resistance of a door when unlocking the door, thereby improving the sense of movement between components.

A tenth aspect is to provide a refrigerator having a structure which is capable of minimizing wear between components when locking a door.

As a result of intensive research, the inventors of the disclosure can achieve solution to the problems and the aforementioned first to tenth aspects by the following embodiments of the disclosure.

To achieve those aspects, a refrigerator according to an embodiment includes a cabinet having a storage chamber, a first door rotatably coupled to the cabinet by a first hinge, a second door coupled to the first door by a second hinge to be rotatable relative to the first door, and a door opening and closing device installed inside the second door to automatically open and close the second door.

The second hinge may include a hinge shaft coupled to one surface of the second door to serve as a central shaft for rotation of the second door, a hinge shaft accommodating portion accommodating the hinge shaft and mounted to be rotatable relative to the hinge shaft, a hinge coupling portion extending from the hinge shaft accommodating portion in a radial direction of the hinge shaft and coupled to the second door to be rotatable around the hinge shaft, a hinge base surrounding the hinge shaft and connected to the first door, an engaging protrusion protruding from one side of the hinge base, and a locking hook mounted to be reciprocally movable along the hinge coupling portion by an operation of the door opening and closing device, and locked to engage with the engaging protrusion or unlocked from the engaging protrusion when the second door is open or closed.

Through this, the locking hook can be automatically operated by the door opening and closing device, thereby automatically locking and unlocking the first door and the second door at the second hinge side.

According to an embodiment, the hinge base may be arranged to overlap one surface of the second door in an axial direction of the hinge shaft. The second hinge may include a hinge connection portion extending in one direction from the hinge base and connected to the first door.

The engaging protrusion may protrude with a gap from the hinge connecting portion in an extension direction of the hinge connecting portion.

Through this, the locking hook and the engaging protrusion can make gaskets between the first door and the second door brought into close contact when the second door is closed, thereby suppressing cool air leakage.

According to an embodiment, the door opening and closing device may include a driving unit, a first magnet unit installed inside the first door, a second magnet unit installed in the second door to be movable in a direction toward or away from the first magnet unit by receiving a driving force from the driving unit, and the door opening and closing device may automatically open and close the second door by a magnetic force acting between the first magnet unit and the second magnet unit.

According to an embodiment, the door opening and closing device may include a first rack extending in one direction inside the second door and installed to be reciprocally movable between a first position and a second position, spaced apart in the one direction, by receiving the driving force of the driving unit, and a second rack connected to the first rack and the second magnet unit to transmit the driving force of the driving unit to the second magnet unit, and installed to be reciprocally movable inside the second door according to a change in position of the first rack.

The second hinge may include a third rack including the locking hook and mounted on the hinge coupling portion to be movable according to a change in position of the second rack, a third magnet unit coupled to the third rack to be movable by a magnetic force acting on the second magnet unit, and a spring elastically supporting the third magnet unit.

Through this, the locking hook can be moved to a lock position with the engaging protrusion by a repulsive force between the third magnet unit and the second magnet unit. The spring can move the locking hook from the lock position to an unlock position by an elastic restoring force.

According to an embodiment, the second door may be open by a repulsive force between the first magnet unit and the second magnet unit when a distance between centers of the first magnet unit and the second magnet unit is smaller than or equal to a first reference distance according to the movement of the first rack to the second position.

The second door may be closed by an attractive force between the first magnet unit and the second magnet unit when the distance between the centers of the first magnet unit and the second magnet unit is greater than or equal to the first reference distance according to the movement of the first rack to the first position.

According to an embodiment, the refrigerator may further include a sensor unit configured to detect an open angle of the second door, and a control unit configured to control the door opening and closing device according to a detection signal of the sensor unit.

The control unit may receive the detection signal from the sensor unit and close the second door when the open angle of the second door is smaller than or equal to a reference angle.

According to an embodiment, the second door may further include a locking device configured to allow the first door and the second door to be locked or unlocked in a state where the second door is closed. The locking device may include a latch bar installed inside the second door to be rotatable around a hinge pin, and a latch hook arranged on one side of the latch bar to be locked to or unlocked from a locking wall, formed on the first door, according to rotation of the latch bar.

According to an embodiment, the locking device may further include a rotary bar coupled to another side of the latch bar to be rotatable around the hinge pin in an opposite direction to the latch hook, and extending in one direction from the another side of the latch bar toward the door opening and closing device.

The door opening and closing device may include a cam arranged on one end of the first rack to face the rotary bar, and configured to convert a linear motion of the first rack into a rotational motion of the rotary bar.

The cam may include a first contact surface formed to be in contact with one end of the rotary bar and inclined in a direction crossing an extension direction of the rotary bar, and a second contact surface extending from the first contact surface in a direction away from the rotary bar, and accommodating the one end of the rotary bar.

According to an embodiment, the one end of the rotary bar may be formed in a hemispherical shape. This can minimize frictional resistance between the one end of the rotary bar and the contact surface of the cam while allowing a smooth contact therebetween.

According to an embodiment, the driving unit may include a motor rotatable in both directions.

The first rack may move to the second position according to rotation of the motor in one direction when the second door is open, and the first rack may move to the first position according to rotation of the motor in an opposite direction when the second door is closed.

According to an embodiment, the door opening and closing device may include a first gear connected to the motor, a second gear engaging with the first gear at a preset gear ratio, and a rack gear formed on one surface of the first rack toward the second gear to engage with the second gear.

Through this, a rotational motion of the second gear can be converted into a linear motion of the rack gear.

According to an embodiment, the door opening and closing device may include an operating protrusion protruding from one surface of the first rack toward the second rack, and a first contact protrusion and a second contact protrusion arranged spaced apart from each other in an extension direction of the first rack with the operating protrusion in between, and protruding from one surface of the second rack toward the one surface of the first rack.

The operating protrusion may be selectively in contact with one of the first contact protrusion and the second contact protrusion according to the change in position of the first rack, so that the driving force of the driving unit is transmitted from the first rack to the second rack.

According to an embodiment, the second door may be arranged in an opposite direction to the storage chamber based on the first door. The first magnet unit may include a first magnet arranged toward the storage chamber and having a first pole, and a second magnet connected to one side surface of the first magnet in the opposite direction to the storage chamber and having a second pole opposite to the first pole.

The second magnet unit may include a third magnet arranged toward the second magnet and having the second pole, and a fourth magnet connected to one side surface of the third magnet in an opposite direction to the second magnet and having the first pole.

The second door may be open by a repulsive force between the second magnet and the third magnet when a distance between centers of the second magnet and the third magnet is smaller than or equal to a first reference distance.

The second door may be closed by an attractive force between the first magnet and the third magnet or an attractive force between the second magnet and the fourth magnet when the distance between the centers of the second magnet and the third magnet is greater than or equal to the first reference distance.

According to an embodiment, the first pole may be an S-pole and the second pole may be an N-pole.

According to an embodiment, the hinge coupling portion may include a mounting portion on which the third rack is slidably mounted, a first step formed in a step manner at one end of the mounting portion, and a second step formed in a step manner at another end of the mounting portion.

The third rack may include a first slide coupled to the mounting portion to be reciprocally movable between the first step and the second step along the mounting portion.

According to an embodiment, the third rack may include a second slide extending from the first slide in a height direction of the second door, and the third magnet unit may be coupled to the second slide and arranged to face the second magnet unit in the one direction.

According to an embodiment, the third magnet unit may include a fifth magnet having a same pole as the second magnet unit. Through this, the second magnet unit and the third magnet unit can interact to generate a repulsive force.

According to an embodiment, the spring may be formed in a coil shape. The third magnet unit may further include a magnet holder accommodating the fifth magnet.

The magnet holder may include a first side wall arranged toward the second magnet unit, and a second side wall arranged to face the first side wall in the one direction and supporting the fifth magnet together with the first side wall.

One end of the spring may be supported on the second side wall, and another end of the spring may be supported on a spring support portion formed to be recessed toward the hinge shaft inside the second door.

According to an embodiment, a side guide protrusion may extend in a direction parallel to the hinge coupling portion inside the second door. The third rack may include a side guide groove formed to be recessed into one surface of the second slide so that the side guide protrusion is coupled, and may move along the side guide protrusion.

Through this, the side guide protrusion can suppress the third rack from being lifted upward due to the repulsive force between the second magnet unit and the third magnet unit.

According to an embodiment, the locking hook may include a first hook portion protruding from the first slide to engage with the engaging protrusion, a second hook portion arranged to overlap one surface of the first slide in a direction of gravity and supported on the one surface of the first slide, and a hook connecting portion connected to the first hook portion and the second hook portion.

Through this, the first slide can connect the locking hook and the third rack.

According to an embodiment, the first hook portion may include a first wall protruding in a first direction parallel to an extension direction of the hinge coupling portion and coupled to be in close contact with one surface of the engaging protrusion in a second direction crossing the first direction when the second door is closed, a second wall spaced apart from the first wall in the second direction, and a connecting wall connected to the first wall and the second wall.

The connecting wall and the hinge coupling portion may be arranged to overlap each other in the direction of gravity.

Through this, the locking hook can have an h-like cross-sectional shape. The locking hook can have both rigidity and elasticity by virtue of the h-like cross-sectional shape.

According to an embodiment, the one surface of the engaging protrusion and the first wall of the first hook portion, which are in close contact with each other when the second door is closed, may be each formed in a flat shape.

Through this, the engaged state between the first hook portion and the engaging protrusion can be firmly maintained.

The first hook portion may include a third wall arranged toward the hinge base and connecting one end of the first wall and one end of the second wall. The third wall of the first hook portion and another surface of the engaging protrusion, which face in opposite directions along the first direction when the second door is closed, may each be formed in a curved shape.

Through this, the first curved portion formed on the third wall and the second curved portion formed on the engaging protrusion can be formed with opposite curvature directions, thereby minimizing wear due to friction.

According to an embodiment, the following effects can be obtained.

First, a first door is rotatably coupled to a front surface of a cabinet by a first hinge. A second door is rotatably connected to the outside of the first door by a second hinge. An automatic door opening and closing device is installed on the second door. The automatic door opening and closing device includes a driving unit, a first magnet unit, and a second magnet unit. The first magnet unit may be installed in the first door, and the second magnet unit may be installed in the second door. The second magnet unit may be mounted inside the second door to be movable toward or away from the first magnet unit.

The second magnet unit may be movable in a left-right direction by receiving a driving force from the driving unit.

Through this, when the second magnet unit is arranged so that a distance between centers of the second magnet unit and the first magnet unit is smaller than or equal to a first reference distance, the second door can be automatically open by a repulsive force acting between the first magnet unit and the second magnet unit.

Second, the automatic door opening and closing device may include a first rack, a rotary bar, and a locking device. The rotary bar may be rotatably coupled to the locking device. The first rack may be installed inside the second door to be movable in the left-right direction by receiving a driving force of a motor from the driving unit.

The first rack may include a cam which is contactable with the rotary bar. The cam includes a first contact surface inclined to be in contact with a contact end of the rotary bar, and a second contact surface accommodating the contact end. The cam and the rotary bar are operated to slide relative to each other. The cam may convert a reciprocal linear motion of the first rack into a rotational motion of the rotary bar. The locking device may be unlocked when the rotary bar rotates toward the front surface of the second door.

Through this, the cam and the rotary bar can operate independently of each other, allowing the second door to be open automatically or manually.

Third, the second door may be locked to the first door by the locking device. Through this, the first door and the second door can be maintained in the coupled state when the first door is open.

Fourth, a sensor unit may detect an open angle of the second door with respect to the first door. A control unit may receive a detection signal from the sensor unit, and control the driving unit when the open angle of the second door is smaller than or equal to a reference angle, so that the second door can be automatically closed.

The door opening and closing device may include a second rack. The first rack includes an operating protrusion for transmitting the driving force to the second rack. The second rack includes a first contact protrusion and a second contact protrusion that are selectively contactable with the operating protrusion depending on the change in position of the first rack. The second rack may transmit the driving force transmitted from the first rack to the second magnet unit.

For example, the second magnet unit may interoperate with the first rack and move away from the first magnet unit. The second magnet unit and the first magnet unit may exert an attractive force on each other when the distance between their centers is greater than or equal to a first reference distance.

The second door may be closed by the attractive force between the first magnet unit and the second magnet unit when the open angle is smaller than or equal to a reference angle.

Fifth, the door opening and closing device may be installed inside the second door and may automatically open or close the second door by a magnetic force acting between the first magnetic unit installed inside the first door and the second magnetic unit installed inside the second door.

For example, the second magnet unit may interoperate with the first rack and move toward the first magnet unit. The second magnet unit and the first magnet unit may exert a repulsive force on each other when the distance between their centers is smaller than or equal to a first reference distance.

Through this, the door opening and closing device can open the second door without interfering with the first door.

Sixth, the door opening and closing device may automatically open and close the second door in a non-contact manner.

Seventh, the second hinge may include a third rack. The third rack may be mounted to slide left and right along a hinge coupling portion of the second hinge. The third rack may include a third magnet unit. The third magnet unit may be positioned apart from the second magnet unit so that a repulsive force acts on the second magnet unit. The third rack may include a spring that elastically supports the third magnet unit.

An elastic restoring force of the spring may act in an opposite direction to the repulsive force between the second and third magnet units. For example, when the second magnet unit approaches the third magnet unit, the second magnet unit moves in one direction along the hinge coupling portion toward a hinge shaft of the second hinge due to the repulsive force. When the second magnet unit moves away from the third magnet unit, the third magnet unit can move in an opposite direction to the one direction along the hinge coupling portion toward the second magnet unit due to the elastic restoring force of the spring.

The third rack may include a locking hook. The locking hook may be installed inside the second door to be rotatable forward and backward and movable left and right together with the third rack.

The second hinge may include a hinge base and an engaging protrusion. The hinge base is coupled to the first door by a hinge connecting portion. The engaging protrusion may protrude from one side of the hinge base to engage with the locking hook. The spring may be compressed by the repulsive force between the second magnet unit and the third magnet unit when the second door is closed.

Through this, the locking hook can engage with the engaging protrusion by the repulsive force between the second magnet unit and the third magnet unit when the second door is closed. Accordingly, automatic closing of the first and second doors can be structurally ensured.

Eighth, before the second door is open, the locking hook may be automatically unlocked from the engaging protrusion by the elastic restoring force of the spring.

Ninth, the locking hook may move away from the engaging protrusion by the elastic restoring force of the spring, so that the second door can be smoothly unlocked and resistance of the door can be reduced, thereby improving the sense of operation of the second door.

Tenth, the locking hook may be mounted on the hinge coupling portion to be movable away from or toward the engaging protrusion when opening or closing the second door, thereby minimizing wear due to friction between components and damage due to interference between components.

### BRIEF DESCRIPTION OF THE DRAWINGS

The above and other aspects, features and other advantages of the disclosure will be more clearly understood from the following detailed description taken in conjunction with the accompanying drawings.

FIG. 1 is a front perspective view of a refrigerator according to an embodiment;

FIG. 2 is a front view of an open state of a second door of a refrigerating chamber door in FIG. 1;

FIG. 3 is a front view of an open state of the refrigerating chamber door and a freezing chamber door in FIG. 1;

FIG. 4 is an enlarged view of a portion “IV” in FIG. 1, which is a conceptual view of a first door and the second door in a state where a locking device is located at a lock position;

FIG. 5 is a conceptual view of an engaging portion of the first door with which the locking device of FIG. 4 engages;

FIG. 6 is a conceptual view of a state in which a door opening and closing device is installed on a lower portion of the second door in FIG. 2;

FIG. 7 is a conceptual view of the door opening and closing device when closing the second door in FIG. 6;

FIG. 8 is a conceptual view of the door opening and closing device when opening the second door in FIG. 6;

FIG. 9 is a conceptual view of a first rack in FIG. 6, viewed from the bottom;

FIGS. 10A and 10B are exploded conceptual views of a rotary bar and a latch bar of the locking device in FIG. 6;

FIG. 11 is a perspective view of relative positions between a first magnet unit and a second magnet unit at a first position of the first rack when closing the second door;

FIG. 12 is a perspective view of relative positions between the first magnet unit and the second magnet unit at a second position of the first rack when opening the second door;

FIGS. 13A, 13B and 13C are conceptual views of changes in the magnetic lines of the first magnet unit and the second magnet unit according to changes in movement position of the first rack when closing the second door;

FIGS. 14A, 14B and 14C are conceptual views of changes in the magnetic lines of the first magnet unit and the second magnet unit according to changes in movement position of the first rack when opening the second door;

FIG. 15 is a conceptual view of a second rack in FIG. 6, viewed from top;

FIG. 16 is a conceptual view of a first contact protrusion of the first rack and an operating protrusion of the second rack being in contact when closing the second door in FIG. 7;

FIG. 17 is a conceptual view of a first contact protrusion of the first rack and an operating protrusion of the second rack being in contact when opening the second door in FIG. 8;

FIG. 18 is an enlarged conceptual view of a portion XVIII in FIG. 6, which shows that a third rack is installed in the second door;

FIG. 19 is a cross-sectional view taken along line XIX-XIX in FIG. 18, which is a conceptual view of a compressed state of an elastic member of the third rack when closing the second door;

FIG. 20 is a cross-sectional view taken along line XX-XX in FIG. 19, which is a conceptual view showing that the third rack is slidably supported by a side guide protrusion;

FIGS. 21A and 21B are conceptual views of a state in which the third rack is mounted on a hinge coupling portion of a second hinge in FIG. 18;

FIG. 22 is an exploded conceptual view of the third rack and the second hinge in FIG. 21;

FIGS. 23A, 23B and 23C are conceptual views of left, right, and lower surfaces of the third rack in FIG. 22;

FIG. 24 is a block diagram of a configuration for controlling opening of the second door of the refrigerator according to the embodiment in FIG. 1;

FIG. 25 is a flowchart of sequential operations of the door opening and closing device and the locking device according to a distance by which the first rack moves by the configuration of FIGS. 1 to 24;

FIG. 26 is a perspective view of the door opening and closing device and locking device at the first position of the first rack when closing the second door, viewed from the rear of the second door;

FIG. 27 is a perspective view of the door opening and closing device and locking device at the second position of the first rack when opening the second door, viewed from the rear of the second door;

FIG. 28 is a perspective view of the door opening and closing device and locking device at the first position of the first rack when closing the second door, viewed from the front of the second door;

FIG. 29 is a perspective view of the door opening and closing device and locking device at the second position of the first rack when opening the second door, viewed from the front of the second door;

FIG. 30 is a perspective view of the door opening and closing device and locking device at the first position of the first rack when closing the second door, viewed from the bottom of the second door;

FIG. 31 is a perspective view of the door opening and closing device and locking device at the second position of the first rack when opening the second door, viewed from the bottom of the second door;

FIG. 32 is a conceptual view of relative positions of the first magnet unit, the second magnet unit, and the third rack at the first position of the first rack when closing the second door in FIG. 30;

FIG. 33 is a conceptual view of relative positions of the first magnet unit, the second magnet unit, and the third rack at the second position of the first rack when opening the second door in FIG. 31;

FIG. 34 is a perspective view of repulsive force between the second magnet unit and the third magnet unit at the first position of the first rack when closing the second door in FIG. 18;

FIG. 35 is a perspective view of positions between the second magnet unit and the third magnet unit at the second position of the first rack when opening the second door in FIG. 34;

FIGS. 36A, 36B, 36C and 36D are conceptual views, viewed at various angles, of an unlocked state of the third rack at the second position of the first rack when opening the second door;

FIGS. 37A, 37B, 37C and 37D are conceptual views, viewed at various angles, of a state before a locking hook of the third rack and an engaging protrusion of a hinge are brought into contact during rotation of the second door from an open state to a closed state;

FIGS. 38A, 38B, 38C and 38D are conceptual views, viewed at various angles, of a state in which the locking hook of the third rack and the engaging protrusion of the hinge are in contact and begin to engage with each other during rotation of the second door from the open state to the closed state;

FIGS. 39A, 39B, 39C and 39D are conceptual views, viewed at various angles, of an engaged state between the locking hook of the third rack and the engaging protrusion of the hinge at the first position of the first rack when closing the second door;

FIGS. 40A and 40B are conceptual views for explaining a wear problem between the locking hook of the third rack and the engaging protrusion of the hinge when the third rack rotates without sliding from the first position of the first rack during the opening and closing operation of the second door; and

FIGS. 41A and 41B are conceptual views showing that the third rack moves left and right and rotates forward and backward between the first and second positions of the first rack during the opening and closing operation of the second door.

### DETAILED DESCRIPTION OF THE EMBODIMENTS

Hereinafter, a refrigerator according to an embodiment will be described in detail with reference to the accompanying drawings. When applying reference numerals to components of each drawing, it should be noted that the same or equivalent components are given the same or equivalent reference numerals even if they are shown on different drawings. In describing an embodiment of the disclosure, when a detailed description of a related known configuration or function is determined to obscure understanding of the embodiment of the disclosure, the detailed description is omitted.

### 1. Definition of Terms

In describing components of embodiments, terms such as first, second, A, B, (a), and (b) may be used. These terms are only intended to distinguish one element from another, and do not limit the nature, order, or sequence of the elements. It will be understood that although the terms first, second, and the like may be used herein to describe various elements, these elements should not be limited by these terms. These terms are generally only used to distinguish one element from another.

It will be understood that when an element is referred to as being “connected with” another element, the element may be connected with the another element or intervening elements may also be present. In contrast, when an element is referred to as being “directly connected with” another element, there are no intervening elements present.

A singular representation may include a plural representation unless it represents a definitely different meaning from the context.

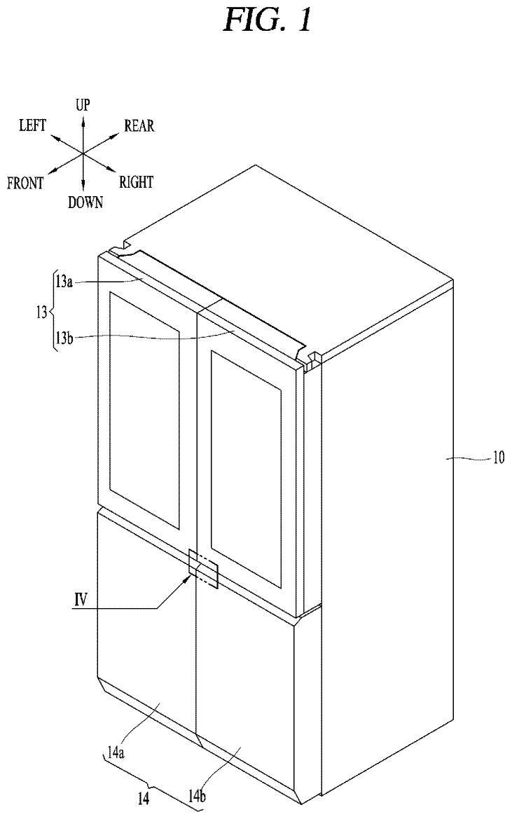

The terms “front,” “rear,” “left,” “right,” “top (or upper)” and “bottom (or lower)” used herein will be understood with reference to a coordinate system shown in FIG. 1.

The term “left-right direction” used in the following description may be referred to as an X-axis direction in an XYZ orthogonal coordinate system. The term “front-rear direction” may refer to a Y-axis direction in the XYZ orthogonal coordinate system. The term “up-down direction” may refer to a Z-axis direction in the XYZ orthogonal coordinate system.

A first door used in the following description may be referred to as an inner door or a main door. A second door may be referred to as an outer door or a sub-door.

The front surface of the second door is a surface which forms the front appearance of a refrigerator door. The rear surface of the second door is a surface facing the first door.

The front surface of the first door is a surface which forms the front appearance of the first door and faces the rear surface of the second door. The rear surface of the first door is a surface facing a cabinet or storage chamber.

### 2. Description of Configuration of Refrigerator According to One Embodiment

Hereinafter, each component of a refrigerator according to an embodiment will be described with reference to the accompanying drawings.

FIG. 1 is a front perspective view of a refrigerator according to an embodiment.

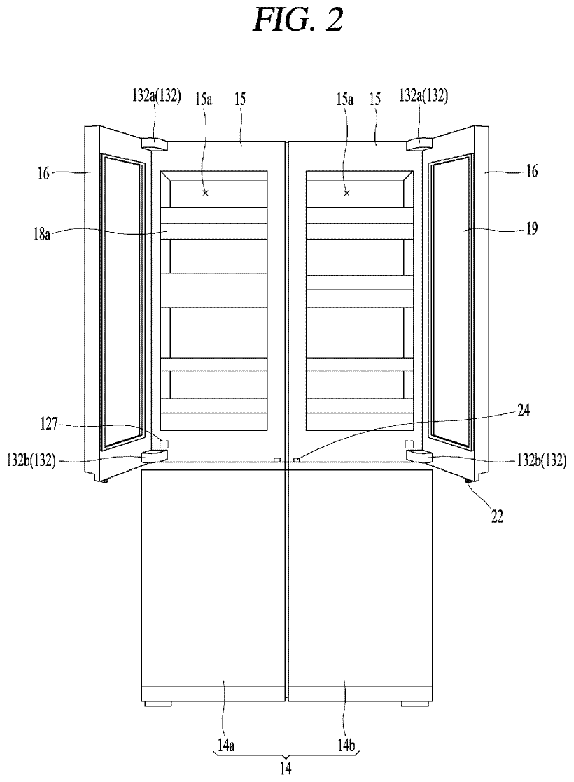

FIG. 2 is a front view of an open state of a second door 16 of a refrigerating chamber door 13 in FIG. 1.

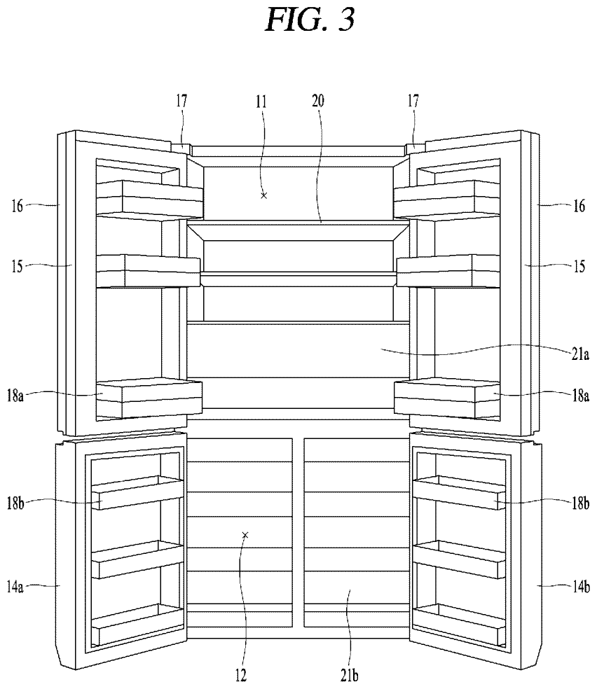

FIG. 3 is a front view of an open state of a refrigerating chamber door 13 and a freezing chamber door 14 in FIG. 1.

Referring to FIGS. 1 to 3, a refrigerator according to an embodiment includes a cabinet 10 and a refrigerator door. The cabinet 10 includes an outer case and an inner case. The outer case forms the appearance of the refrigerator. The inner case forms a storage chamber 11, 12 inside. An insulating material is arranged between the outer case and the inner case. The insulating material blocks heat transfer due to a temperature difference between the outside of the cabinet 10 and the storage chamber 11, 12.

The refrigerator door may open and close the storage chamber 11, 12.

The storage chamber 11, 12 may include a refrigerating chamber 11 and a freezing chamber 12. Although not limited, in this embodiment, the refrigerating chamber 11 may be located above the freezing chamber 12.

Depending on the shape of the refrigerator, the freezing chamber 12 and refrigerating chamber 11 may be arranged on the left and right, or the freezing chamber 12 may be positioned above the refrigerating chamber 11.

The refrigerator door may include a refrigerating chamber door 13 and a freezing chamber door 14. The refrigerating chamber door 13 may be rotatably mounted on a front surface of the cabinet 10 to open and close the refrigerating chamber 11. The freezing chamber door 14 may be rotatably mounted on the front surface of the cabinet 10 to open and close the freezing chamber 12.

The refrigerating chamber door 13 may include a pair of doors. One of the pair of doors, for example, a first refrigerating chamber door 13a, may be arranged on the left side of the cabinet 10. The other of the pair of doors, for example, a second refrigerating chamber door 13b may be arranged on the right side of the cabinet 10.

The first refrigerating chamber door 13a opens and closes a portion of the refrigerating chamber 11. The second refrigerating chamber door 13b may open and close the other portion of the refrigerating chamber 11.

The freezing chamber door 14 may include a pair of doors. One of the pair of doors, for example, a first freezing chamber door 14a, may be arranged on the left side of the cabinet 10. The other of the pair of doors, for example, a second freezing chamber door 14b may be arranged on the right side of the cabinet 10.

The first freezing chamber door 14a opens and closes a portion of the freezing chamber 12. The second freezing chamber door 14b may open and close the other portion of the freezing chamber 12.

In another example, the freezing chamber 12 may be partitioned left and right or up and down, and the first freezing chamber door 14a may open and close one partitioned space, and the second freezing chamber door 14b may open and close the other partitioned space.

This specification states that there is no limitation on the number or arrangement of the refrigerating chamber door 13 and freezing chamber door 14. For example, the storage chamber 11, 12 may include only the refrigerating chamber 11.

At least one of the first and second refrigerating chamber doors 13a and 13b may include a first door 15 which opens and closes at least a portion of the refrigerating chamber 11, and a second door 16 which is rotatable relative to the first door 15.

This embodiment shows an example in which each of the first and second refrigerating chamber doors 13a and 13b includes the first door 15 and the second door 16.

The first door 15 may be rotatably connected to the cabinet 10 by a first hinge 17. The first hinge 17 may be arranged as a plurality of first hinges. The plurality of first hinges 17 may rotatably support the first and second refrigerating chamber doors 13a and 13b.

The first hinge 17 may include a first upper hinge, a first middle hinge, and a first lower hinge.

The first upper hinge may connect the upper side of the first door 15 and the upper side of the cabinet 10. The first middle hinge may connect a lower side of the first door 15 and a middle portion of the cabinet 10. The first middle hinge and the first lower hinge may rotatably support the first and second freezing chamber doors 14a and 14b.

The first middle hinge may connect an upper side of the freezing chamber door 14 and a middle portion of the cabinet 10. The first lower hinge may connect a lower side of the freezing chamber door 14 and a lower side of the cabinet 10.

The second door 16 may be rotatable relative to the first door 15. The second hinge 132 may connect the first door 15 and the second door 16 such that the second door 16 can rotate relative to the first door 15.

The second hinge 132 may be arranged as a plurality of second hinges. The plurality of second hinges 132 may rotatably support the corresponding second doors 16 of the first and second refrigerating chamber doors 13a and 13b.

The second hinge 132 may include a second upper hinge 132a and a second middle hinge 132b. The second upper hinge 132a may connect upper sides of the first door 15 and the second door 16. The second middle hinge 132b may connect lower sides of the first door 15 and the second door 16.

The first door 15 may include an opening 15a. The second door 16 may open and close the opening 15a.

The second door 16 may cover the opening 15a on the front surface of the first door 15. In another example, the second door 16 may cover the opening 15a while at least a portion of the second door 16 is accommodated in the opening 15a.

The first door 15 may include at least one basket 18a. The basket 18a may be mounted on a rear surface of the first door 15 or a surface forming the opening 15a.

At least one of the first and second freezing chamber doors 14a and 14b may include a basket 18b. This embodiment shows an example in which the basket 18b is arranged on each of the first and second freezing chamber doors 14a and 14b.

The second door 16 may include a panel assembly 19. The panel assembly 19 may include at least one panel which is formed of a glass material or a material that allows light transmission.

When a lighting unit arranged in the refrigerator is turned on, the storage chamber 11, 12 or the inside of the first door 15 can be visually seen through the panel assembly 19 while the second door 16 is closed.

In some embodiments, at least one shelf 20 may be arranged in the refrigerating chamber 11. At least one drawer 21a may be arranged in the refrigerating chamber 11 to be drawn in and out in a sliding manner.

At least one drawer 21b may be arranged in the freezing chamber 12 to be drawn in and out in a sliding manner. Of course, the shelf 20 or the drawers 21a and 21b are optional and may be omitted.

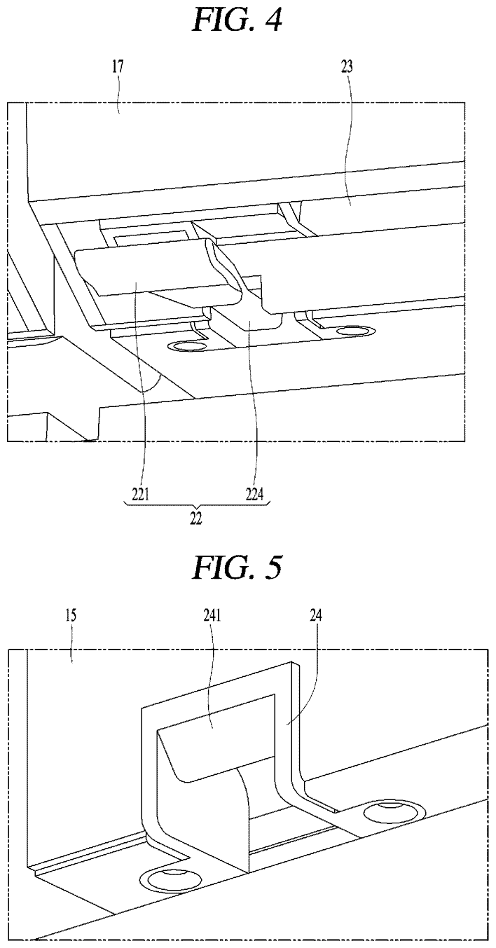

FIG. 4 is an enlarged view of a portion “IV” in FIG. 1, which is a conceptual view of the first door 15 and the second door 16 in a state where a locking device 22 is located at a lock position.

FIG. 5 is a conceptual view of an engaging portion 24 of the first door 15 with which the locking device 22 of FIG. 4 engages.

Referring to FIGS. 1 to 5, the first door 15 may be open manually or automatically.

In the case of automatically opening the first door 15, although not shown, a main opening device for opening the first door 15 may be arranged in the first door 15 or the cabinet 10.

The location or structure of the main opening device for opening the first door 15 may employ various technologies previously disclosed by the applicant of the disclosure. That is, as the first door 15 is open by the main opening device, the first door 15 and the second door 16 can rotate together. Of course, the main opening device may be omitted.

The second door 16 may be open while the first door 15 is closed. The first door 15 may be open while the second door 16 is closed.

At this time, when the first door 15 is open, it is necessary to suppress the second door 16 from rotating relative to the first door 15.

Therefore, in this embodiment, the refrigerating chamber door 13 may further include a locking device 22 which allows the first door 15 and the second door 16 to remain locked or unlocked.

The locking device 22 may move from a lock position to an unlock position. The locking device 22 may return from the unlock position to the lock position.

The locking device 22 may be moved by the user's manual operation. The locking device 22 may be automatically moved by a door opening and closing device to be described later.

For example, when manual opening of the second door 16 is required, the user may operate the locking device 22 to move from the lock position to the unlock position.

When the locking device 22 moves to the unlock position, the second door 16 and the first door 15 may be in the unlocked state.

For example, when the user presses upward an operating unit 221 of the locking device 22, which protrudes downward below a lower surface of the second door 16, the locking device 22 may be unlocked.

The locking device 22 may be rotatably arranged on the second door 16. The second door 16 may include a handle 23. The handle 23 may be recessed into one side of the second door 16.

For example, the handle 23 may be arranged on the lower side of the second door 16.

The locking device 22 may be arranged on the lower side of the second door 16. The locking device 22 may be located outside the handle 23. In another example, the locking device 22 may be positioned inside a recessed space formed by the handle 23.

The first door 15 and the second door 16 may be locked in the lock position of the locking device 22. In this state, when the user pulls the handle 23, the first door 15 and the second door 16 can rotate together.

When the user pulls the handle 23 while the second door 16 and the first door 15 are unlocked, the second door 16 can be rotated while the first door 15 is closed.

The first door 15 may include an engaging portion 24 with which the locking device 22 engages. The engaging portion 24 may be formed integrally with or coupled to a member which defines the appearance of the first door 15.

The engaging portion 24, for example, may be located on the lower side of the first door 15.

The engaging portion 24 may form a space for accommodating a portion of the locking device 22. The engaging portion 24 may include an engaging wall 241 with which the portion of the locking device 22 located inside the space engages.

A front surface of the engaging wall 41 may include an inclined surface. During the process that the second door 16 is open and then closed, the locking device 22 can easily move into the space by moving along the inclined surface.

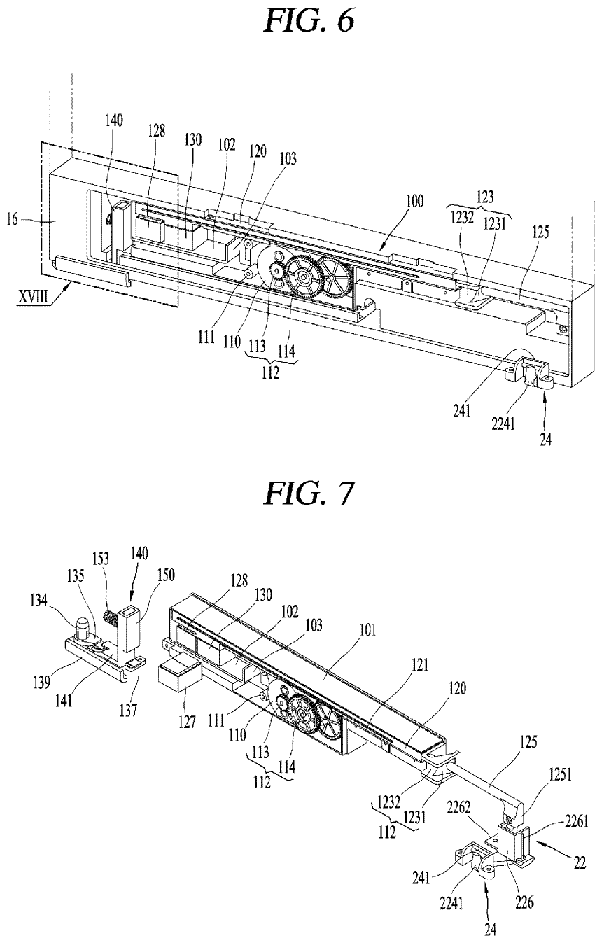

FIG. 6 is a conceptual view of a state in which the door opening and closing device 100 is installed on a lower portion of the second door 16 in FIG. 2.

FIG. 7 is a conceptual view of the door opening and closing device 100 when closing the second door 16 in FIG. 6.

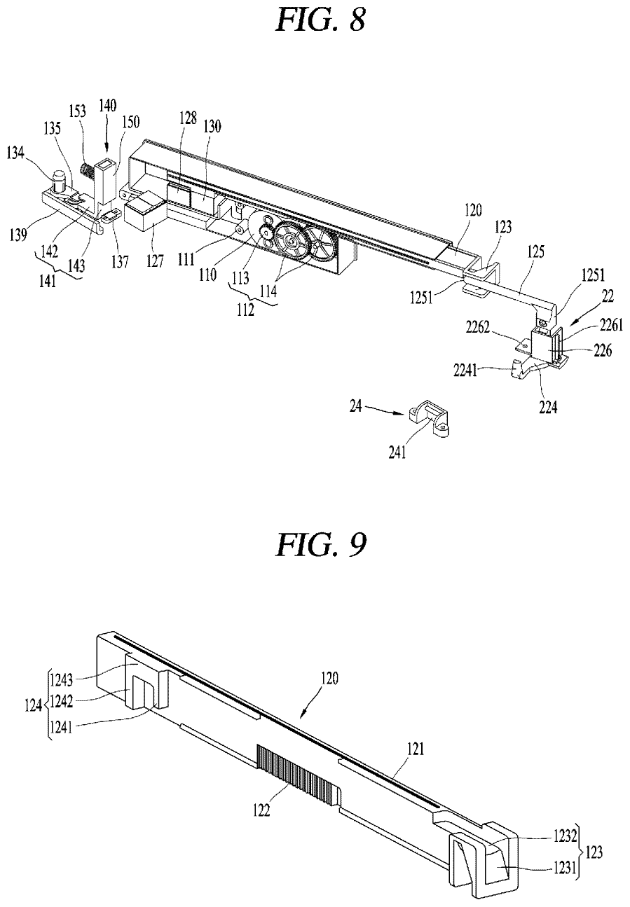

FIG. 8 is a conceptual view of the door opening and closing device 100 when opening the second door 16 in FIG. 6.

FIG. 9 is a conceptual view of a first rack 120 of FIG. 6, viewed from the bottom.

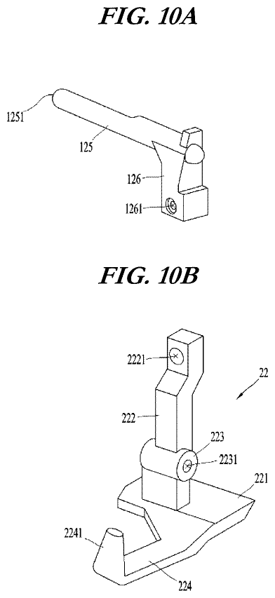

FIG. 10 is an exploded conceptual view of a rotary bar 125 and a latch bar 222 of the locking device 22 in FIG. 6.

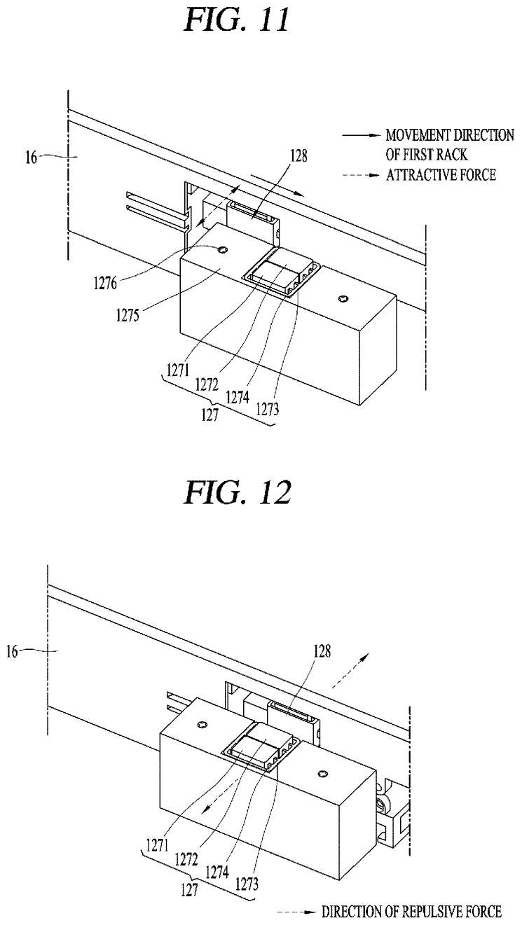

FIG. 11 is a perspective view of relative positions between a first magnet unit 127 and a second magnet unit 128 at a first position of the first rack 120 when closing the second door 16.

FIG. 12 is a perspective view of relative positions between the first magnet unit 127 and the second magnet unit 128 at the first position of the first rack 120 when opening the second door 16.

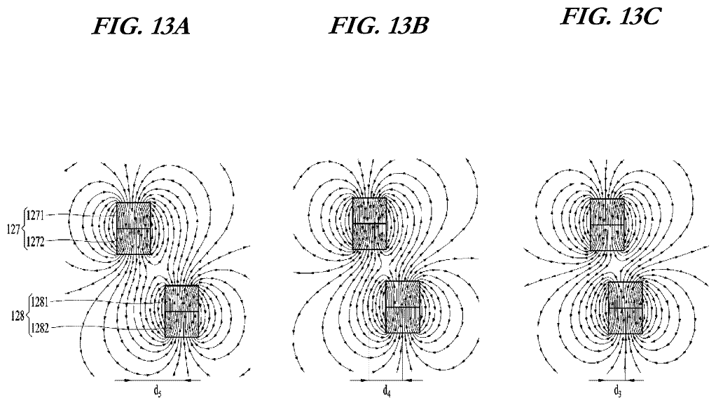

FIG. 13 is a conceptual view of changes in the magnetic lines of the first magnet unit 127 and the second magnet unit 128 according to changes in movement position of the first rack 120 when closing the second door 16.

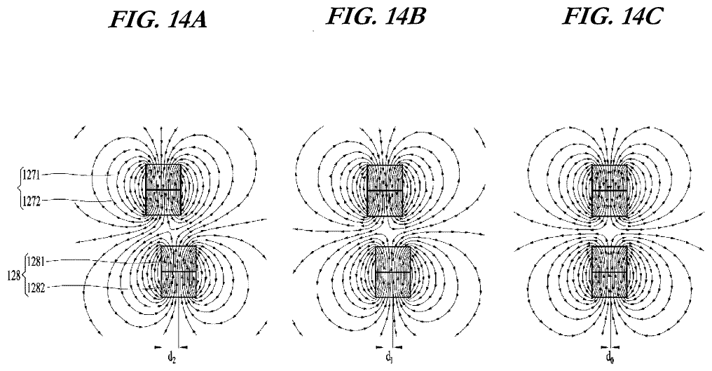

FIG. 14 is a conceptual view of changes in the magnetic lines of the first magnet unit 127 and the second magnet unit 128 according to changes in movement position of the first rack 120 when opening the second door 16.

FIG. 15 is a conceptual view of a second rack 130 in FIG. 6, viewed from top.

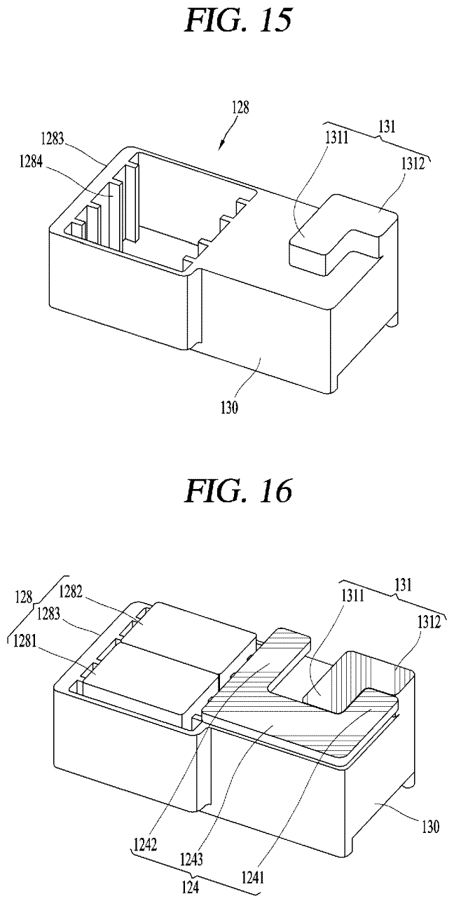

FIG. 16 is a conceptual view of a first contact protrusion 1241 of the first rack 120 and an operating protrusion 131 of the second rack 130 being in contact when closing the second door 16 in FIG. 7.

FIG. 16 is a conceptual view of a second contact protrusion 1242 of the first rack 120 and the operating protrusion 131 of the second rack 130 being in contact when opening the second door 16 in FIG. 8.

The refrigerator includes a door opening and closing device 100. The door opening and closing device 100 is configured to automatically open the second door 16. The second door 16 may be rotatable relative to the first door 15 by the door opening and closing device 100.

To open the second door 16, the first door 15 and the second door 16 must be unlocked first. The door opening and closing device 100 is configured to operate the locking device 22 of the second door 16 to the unlock position.

For this purpose, the door opening and closing device 100 may be arranged adjacent to the locking device 22. For example, the door opening and closing device 100 may be installed on the second door 16. In this embodiment, the locking device 22 may be a separate component from the door opening and closing device 100 or may be a component which constitutes the door opening and closing device 100.

The door opening and closing device 100 may include a driving unit 110. The driving unit 110 may include a motor. The motor may be configured to rotate in both directions.

The door opening and closing device 100 may further include a case 101. The case 101 may be installed in a lower portion of the second door 16. The case 101 may be accommodated inside the second door 16. A portion of the case 101 may be omitted and a wall of the second door 16 may serve as the case 101.

The case 101 may be formed in a rectangular shape which is long in one direction. The case 101 may extend such that a length in a left-right direction of the second door 16 is greater than a height in an up-down direction and a width in a front-rear direction.

The case 101 may support the components constituting the door opening and closing device 100, fix the positions of the components, or guide the movement of the components.

The driving unit 110 may be accommodated inside the case 101. A fastening portion 111 may protrude from one side of the driving unit 110. The driving unit 110 may be fastened to the case 101 by the fastening portion 111.

The door opening and closing device 100 may further include a driving force transmission unit 112. The driving force transmission unit 112 may be accommodated inside the case 101. The driving force transmission unit 112 may include a plurality of gears, for example. Each of the plurality of gears may be rotatably installed in the case 101.

The plurality of gears include a first gear 113 and a second gear 114. The first gear 113 may be connected to a shaft of the motor. The second gear 114 may be provided in plurality. The first gear 113 and the second gear 114 may each be implemented as a pinion gear.

The first gear 113 and the second gear 114 may be formed in a circular shape. The first gear 113 and the second gear 114 may have different diameters, and the number of teeth formed on an outer circumferential surface of each gear may be different. The plurality of second gears 114 may have different diameters and different numbers of teeth.

At least one of the plurality of second gears 114 may engage with the first gear 113. At least one other of the plurality of second gears 114 may engage with a rack gear 122 of the first rack 120, which will be described later.

Through this, the first gear 113 and the second gear 114 can reduce a rotational speed of the motor according to a preset gear ratio. Accordingly, the first gear 113 and the second gear 114 can increase a rotational torque of the motor.

The first gear 113 and the second gear 114 can generate a large rotational force even when the driving force of the motor is small, thereby reducing the size and power consumption of the motor.

The door opening and closing device 100 may include a first rack 120. The first rack 120 may be installed in the case 101 to perform a linear reciprocating motion in one direction or an opposite direction. In this specification, a rack may be referred to as a moving member in that it can make a linear motion in both directions. Here, both directions may mean, for example, left and right directions.

The first rack 120 may be formed in a rectangular shape. The first rack 120 may be formed such that a length in one direction is greater than a height in the up-down direction and a width in the front-rear direction. A first guide groove 121 may be formed concavely on each of front and rear surfaces of the first rack 120. The first guide groove 121 may extend along the left-right direction on each of the front and rear surfaces of the first rack 120.

A plurality of guide protrusions may protrude the inner surface of the case 101 to face the guide grooves 121. The plurality of guide protrusions may be inserted into the corresponding guide grooves 121. Through this, the first rack 120 can move left and right along the guide protrusions.

A penetrating portion may be formed through one end of the case 101 toward the locking device 22. One end of the first rack 120 may extend to protrude toward the locking device 22 through the penetrating portion of the case 101.

A rack gear 122 may be formed on a lower surface of the first rack 120. The rack gear 122 may extend in one direction. The rack gear 122 may engage with the second gear 114 described above. Through this, the rack gear 122 can convert the rotational motion of the first gear 113 and the second gear 114 into a linear motion.

The first rack 120 may perform a reciprocal linear motion by receiving a driving force from the driving unit 110 through the first gear 113, the second gear 114, and the rack gear 122.

A cam 123 may be formed on one end of the first rack 120. The cam 123 may be configured to convert the linear motion into the rotational motion or vice versa. The cam 123 may be configured to transmit the driving force from the first rack 120 to the locking device 22.

The cam 123 may be formed in a rectangular shape. The cam 123 may include a first contact surface 1231 and a second contact surface 1232.

The first contact surface 1231 may be arranged toward a rotary bar 125 to be described later. The first contact surface 1231 may be arranged to be contactable with one end of the rotary bar 125. The first contact surface 1231 may be inclined in the left-right direction with respect to the front-rear direction.

When the second door 16 is closed and the first rack 120 is in a first position, a distance between the rear end of the first contact surface 1231 and one end of the rotary bar 125 may be longer than a distance between the front end of the first contact surface 1231 and the one end of the rotary bar 125.

The front end of the first contact surface 1231 may be a starting point where a contact with the one end of the rotary bar 125 starts. The rear end of the first contact surface 1231 may be an ending point where the contact with the one end of the rotary bar 125 ends.

Through this, the first contact surface 1231 can induce a rotational motion of the rotary bar 125 in the front-rear direction between the starting point and the ending point of the contact with the rotary bar 125.

The second contact surface 1232 may be formed to be concave forward on the rear surface of the cam 123. The second contact surface 1232 may extend from an edge of the rear end of the first contact surface 1231 in the left-right direction. The second contact surface 1232 may be formed in a curved shape to be in surface contact with an outer circumferential surface of the rotary bar 125.

Through this, the rotary bar 125 can be accommodated in the second contact surface 1232 and can slide left and right in a surface contact state. In the contact state with the rotary bar 125, the second contact surface 1232 can support the rotary bar 125 so that the rotary bar 125 remains rotated in a rearward direction. Here, the rearward direction is a direction toward the first door 15.

The rotary bar 125 may be formed in a cylindrical shape. The rotary bar 125 may extend in the left-right direction. A contact end 1251 may be formed on one end of the rotary bar 125. The contact end 1251 may be formed in a spherical shape. Accordingly, the contact end 1251 can minimize wear due to friction with the first contact surface 1231.

The contact end 1251 of the rotary bar 125 may rotate by receiving the driving force through the movement of the cam 123 while being in contact with the first contact surface 1231 and the second contact surface 1232.

A coupling portion 126 may be formed on another end of the rotary bar 125. The coupling portion 126 may extend downward from the other end of the rotary bar 125 toward the locking device 22. A coupling hole 1261 may be formed through the coupling portion 126 in the front-rear direction.

A coupling space may be formed inside the coupling portion 126 so that the upper end of the locking device 22 can be inserted. The coupling portion 126 of the rotary bar 125 may be fitted to surround the upper end of the locking device 22.

The locking device 22 may include a latch bar 222 and a latch 224. The latch bar 222 may extend in the up-down direction. The upper end of the latch bar 222 may be inserted into the coupling portion 126 of the rotary bar 125. A fastening hole 2221 may be formed on the upper end of the latch bar 222.

The fastening hole 2221 may be arranged to overlap the coupling hole 1261 of the coupling portion 126 in the front-rear direction. Through this, a fastening member, such as a screw, can be coupled to the coupling portion 126 and the latch bar 222 through the coupling hole 1261 and the fastening hole 2221. The latch bar 222 of the locking device 22 and the rotary bar 125 can be fastened by the fastening member.

A boss portion 223 may be formed on a lower portion of the latch bar 222. A hinge pin accommodating hole 2231 may be formed inside the boss portion 223 in the left-right direction. A hinge pin 225 may be rotatably coupled to a supporter 226, which will be described later, through the hinge pin accommodating hole 2231.

The supporter 226 may be installed in a lower portion of the second door 16. The supporter 226 may be arranged in a left end or a right end of the second door 16. When the second door 16 is located on the right side of the cabinet 10, the supporter 226 may be arranged in the left end of the second door 16. When the second door 16 is located on the left side of the cabinet 10, the supporter 226 may be arranged in the right end of the second door 16.

The supporter 226 may be configured to surround at least one surface of the latch bar 222. This embodiment shows an example in which the supporter 226 surrounds a left surface, a right surface, and a rear surface of the latch bar 222.

A coupling protrusion 2261 may protrude from a right surface of the supporter 226. Accordingly, the coupling protrusion 2261 can be coupled to the second door 16.

A fastening plate 2262 may protrude from a left surface of the supporter 226. A fastening hole may be formed through the fastening plate 2262 in the up-down direction. The fastening plate 2262 may be fastened to the second door 16 by a fastening member, such as a screw, which is inserted through the fastening hole.

The hinge pin 225 may be rotatably mounted between the left and right surfaces of the supporter 226. The hinge pin 225 may support the latch bar 222 so that the latch bar 222 can rotate in the front-rear direction.

The latch 224 may be arranged on a lower end of the latch bar 222. The latch 224 may extend from the lower end of the latch bar 222 in the front-rear direction. For example, the latch 224 may protrude rearward from the lower end of the latch bar 222 toward the lower end of the first door 15.

A latch hook 2241 may protrude upward from a rear end of the latch 224. The latch hook 2241 may be locked by being caught on the engaging portion 24 of the first door 15 described above.

An operating unit 221 may be arranged on the lower end of the latch bar 222. The operating unit 221 may extend from the lower end of the latch bar 222 in the front-rear direction. For example, the operating unit 221 may protrude forward in an opposite direction to the latch 224 based on the latch bar 222 to be exposed to the front of the second door 16.

Through this, the operating unit 221 can be manually operated by the user.

A length between the rotary bar 125 and the hinge pin 225 along the length of the latch bar 222 may be longer than a length between the latch 224 and the hinge pin 225.

Through this, a rotation angle of the rotary bar 125 can be greater than a rotation angle of the latch 224.

The locking device 22 may be locked or unlocked automatically or manually.

For example, the locking device 22 may be automatically unlocked.

The latch bar 222 may rotate forward and backward around the hinge pin 225 by receiving the driving force from the rotary bar 125.

The upper end of the latch bar 222 may rotate rearward toward the first door 15, while the lower end of the latch bar 222 may rotate forward toward the front surface of the second door 16. The latch 224 located on the lower end of the latch bar 222 rotates forward.

The latch hook 2241 may rotate from the lock position of the latch hook 2241 to the unlock position of the latch hook 2241. The lock position may be positioned higher than the unlock position.

The door opening and closing device 100 may include a first magnet unit 127 and a second magnet unit 128. The first magnet unit 127 may be arranged on the first door 15. The second magnet unit 128 may be arranged on the second door 16. The first magnet unit 127 and the second magnet unit 128 may be configured to automatically open the second door 16 through magnetic interaction.

The first magnet unit 127 may be fixedly installed in a lower portion of the first door 15. The first magnet unit 127 may be accommodated in the first door 15. The second magnet unit 128 may be fixedly installed in a lower portion of the second door 16. The second magnet unit 128 may be accommodated in the second door 16. Through this, the first magnet unit 127 and the second magnet unit 128 can be covered by the first door 15 and the second door 16 without being exposed to the outside of the first door 15 and the second door 16, thereby making the appearance of the first door 15 and the second door 16 beautiful.

The second magnet unit 128 may exert an attractive force on the first magnet unit 127 when the second door 16 is closed. The second magnet unit 128 may be configured to exert a repulsive force on the first magnet unit 127 when the second door 16 is open.

For this purpose, the second magnet unit 128 is located in front of the first magnet unit 127. The second magnet unit 128 may be installed movably between the first position and the second position inside the second door 16. The second magnet unit 128 may be installed movably inside the case 101.

The second magnet unit 128 may move left and right with respect to the first magnet unit 127. The second magnet unit 128 may move in a direction toward a second hinge 132 or move in a direction away from the second hinge 132.

Here, the first position may be a position of the second magnet unit 128 when the second door 16 is closed, and the second position may be a position of the second magnet unit 128 when the second door 16 is open.

When the second magnet unit 128 is located at the first position, the first magnet unit 127 and the second magnet unit 128 may be arranged not to overlap in the front-rear direction. When the second magnet unit 128 is located at the first position, the attractive force may act between the first magnet unit 127 and the second magnet unit 128.

When the second magnet unit 128 is located at the second position, the first magnet unit 127 and the second magnet unit 128 may be arranged to overlap in the front-rear direction. When the second magnet unit 128 is located at the second position, centers of the first magnet unit 127 and the second magnet unit 128 may be aligned in the front-rear direction. When the second magnet unit 128 is located at the second position, the repulsive force may act between the first magnet unit 127 and the second magnet unit 128.

A distance between the second magnet unit 128 and the second hinge 132 when the second magnet unit 128 is located at the first position may be smaller than a distance between the second magnet unit 128 and the second hinge 132 when the second magnet unit 128 is located at the second position.

The second hinge 132 may include a second middle hinge 132b. The second hinge 132 may be installed on the lower surface of the second door 16. The second hinge 132 may be installed on one end of the second door 16 in the left-right direction.

The second hinge 132 includes a hinge shaft 133 forming a center of rotation. The hinge shaft 133 may extend in the up-down direction. The hinge shaft 133 may be installed to be embedded in the second door 16.

The second hinge 132 may include a hinge shaft accommodating portion 134 and a hinge coupling portion 135. The hinge shaft accommodating portion 134 is formed to surround the hinge shaft 133. The hinge shaft accommodating portion 134 may be formed in a cylindrical shape. The hinge shaft accommodating portion 134 may include an accommodation space to accommodate the hinge shaft 133.

An upper end of the hinge shaft accommodating portion 134 is blocked, while a lower end of the hinge shaft accommodating portion 134 is open downward. The hinge shaft 133 may be rotatably accommodated in the hinge shaft accommodating portion 134 through a lower opening of the hinge shaft accommodating portion 134.

The hinge coupling portion 135 may extend along a lower surface of the second door 16 in a radial direction of the hinge shaft accommodating portion 134 from the lower end of the hinge shaft accommodating portion 134. The hinge coupling portion 135 may be coupled to the lower surface of the second door 16.

A hinge fastening portion 137 may be coupled to or integrally formed with an end of the hinge coupling portion 135. This embodiment shows an example in which the hinge fastening portion 137 manufactured to be detachable from the hinge coupling portion 135 is coupled to the hinge coupling portion 135.

The hinge fastening portion 137 may extend in a direction crossing a longitudinal direction of the hinge coupling portion 135. For example, the hinge fastening portion 137 may extend in the front-rear direction. A coupling groove 1371 may be formed at a center of the hinge coupling portion 137.

A coupling groove 1371 may be formed at a center of the hinge coupling portion 135. Fastening holes 1372 may be formed at front and rear ends of the hinge fastening portion 137, respectively, with the coupling groove 1371 of the hinge fastening portion 137 in between. Fastening members, such as screws, may be fastened to the lower surface of the second door 16 through the fastening holes 1372 of the hinge fastening portion 137, thereby fastening the hinge coupling portion 135 to the second door 16.

When the second magnet unit 128 is located between the first position and the second position of the first rack 120, attractive and repulsive forces may coexist between the first magnet unit 127 and the second magnet unit 128.

The attractive force may increase as the second magnet unit 128 moves toward the first position or away from the second position. The repulsive force may increase as the second magnet unit 128 moves toward the second position or away from the first position.

The first magnet unit 127 may include a first magnet 1271 and a second magnet 1272. The first magnet 1271 and the second magnet 1272 may extend in the front-rear direction and may be arranged continuously in the front-rear direction. Here, the first magnet 1271 and the second magnet 1272 may denote one permanent magnet.

The first magnet 1271 and the second magnet 1272 are areas of the permanent magnet which are divided for convenience in explaining the magnetic characteristics of the permanent magnet. Ends of the first magnet 1271 and the second magnet 1272 each have opposite polarities.

The respective areas of the first magnet 1271 and the second magnet 1272 do not represent physical sizes. Even if the first magnet 1271 is cut in half, the opposite ends of the first magnet 1271 may have opposite polarities.

An end of the first magnet 1271 may be an S-pole, and an end of the second magnet 1272 may be an N-pole. However, the polarities of the first magnet 1271 and the second magnet 1272 are not limited thereto and may be switched. The first magnet 1271 may be arranged at the rear of the second magnet 1272. The first magnet 1271 may be connected to a rear surface of the second magnet 1272. Here, the rear surface of the second magnet 1272 is arranged to face the rear surface of the first door 15.

The first magnet 1271 may be arranged toward the storage chamber 11, 12 or the refrigerating chamber 11. The second magnet 1272 may be arranged toward the second door 16.

The first magnet unit 127 may include a first magnet holder 1273 which accommodates the first magnet 1271 and the second magnet 1272. A plurality of first compression ribs 1274 may be arranged inside the first magnet holder 1273. The first compression ribs 1274 may protrude into an inner space along a circumferential surface of the first magnet holder 1273.

The first compression ribs 1274 may be compressed onto a magnet when the magnet is accommodated. Through this, the first compression ribs 1274 can restrict the movement of the magnet inside the first magnet holder 1273.

Magnet fastening portions 1275 may be arranged on both side surfaces of the first magnet holder 1273. Fastening holes 1276 may be formed through the magnet fastening portions 1275, respectively, in the up-down direction. The magnet fastening portions 1275 may fasten the first magnet holder 1273 to the first door 15 by inserting fastening members, such as screw, through the fastening holes 1276.

The second magnet unit 128 may include a third magnet 1281 and a fourth magnet 1282. The third magnet 1281 and the fourth magnet 1282 may extend in the front-rear direction and may be arranged continuously in the front-rear direction. Here, the third magnet 1281 and the fourth magnet 1281 may denote one permanent magnet.

The third magnet 1281 and the fourth magnet 1282 are only areas of the permanent magnet which are divided for convenience in explaining the magnetic characteristics of the permanent magnet (having opposite polarities at both ends of the magnet), and the magnetic characteristics of N-pole and S-pole cannot be physically separated or attached.

An end of the third magnet 1281 may be an N-pole, and an end of the fourth magnet 1282 may be an S-pole. The third magnet 1281 may be arranged at the rear of the fourth magnet 1282. The third magnet 1281 may be connected to a rear surface of the fourth magnet 1282. Here, the rear surface of the fourth magnet 1282 is arranged to face the rear surface of the second door 16.

The third magnet 1281 may be arranged toward the first door 15. The fourth magnet 1282 may be arranged toward the front surface of the second door 16.

The second magnet unit 128 may include a second magnet holder 1283 which accommodates the third magnet 1281 and the fourth magnet 1282. A plurality of second compression ribs 1284 may be arranged inside the second magnet holder 1283. The second compression ribs 1284 may protrude into an inner space along a circumferential surface of the second magnet holder 1283.

The second compression ribs 1284 may be compressed onto a magnet when the magnet is accommodated. Through this, the second compression ribs 1284 can restrict the movement of the magnet inside the second magnet holder 1283.

When the first magnet unit 127 is accommodated inside the first door 15, the first magnet unit 127 is covered by an outer wall of the first door 15 and is not exposed to the outside. When the second magnet unit 128 is accommodated inside the second door 16, the second magnet unit 128 is also covered by an outer wall of the second door 16 and is not exposed to the outside.

The first magnet unit 127 and the second magnet unit 128 do not contact each other. Through this, the first magnet unit 127 and the second magnet unit 128 do not have to be in physical contact with each other, which can suppress damage to components due to the physical contact, for example, marks remaining on the rear surface of the second door 16, when opening the second door 16.

The first magnet 1271 and the fourth magnet 1282 may be located at positions far from each other in the front-rear direction. The first magnet 1271 and the fourth magnet 1282 have the same polarity. The second magnet 1272 and the third magnet 1281 may be arranged close to each other. The second magnet 1272 and the third magnet 1281 have the same polarity.

The second magnet 1272 and the third magnet 1281 may be arranged to be offset from (not to overlap) each other in the front-rear direction according to a movement change of the second magnet unit 128. In another example, the second magnet 1272 and the third magnet 1281 may be arranged to face (overlap) each other in the front-rear direction according to the movement change of the second magnet unit 128.

Referring to FIG. 13, when the second magnet unit 128 moves from right to left toward the first magnet unit 127, a distance d3, d4, d5 between centers of the first magnet unit 127 and the second magnet unit 128 increases (i.e., d3<d4<d5) as it goes from (c) to (a). Here, d3 may be a preset distance.

As shown in FIG. 13, when a distance between the centers of the first magnet unit 127 and the second magnet unit 128 increases to be greater than or equal to the preset distance, lines of magnetic force may be connected between the first magnet 1271 and the third magnet 1281 or between the second magnet 1272 and the fourth magnet 1282.

In the case of (c), an attractive force acting between the first magnet 1271 (S-pole) and the third magnet 1281 (N-pole) may overcome the repulsive force acting between the second magnet 1272 (N-pole) and the third magnet 1281 (N-pole). Therefore, the attractive force can act between the first magnet unit 127 and the second magnet unit 128.

In the case of (a), the second magnet unit 128 is located at the first position.

Referring to FIG. 14, when the second magnet unit 128 moves from right to left toward the first magnet unit 127, a distance d2, d1, d0 between the centers of the first magnet unit 127 and the second magnet unit 128 decreases (i.e., d2>d1>d0) as it goes from (d) to (f). As closed curves increase among the lines of magnetic force of the first magnet unit 127 or the second magnet unit 128, the repulsive force can increase.

As shown in FIG. 14, when the distance between the centers of the first magnet unit 127 and the second magnet unit 128 is smaller than or equal to a preset distance d1, the second door 16 may be open by the repulsive force acting between the first magnet unit 127 and the second magnet unit 128.

In the case of being smaller than or equal to the distance d1 (d2>d1>d0) of (e), the repulsive force acting between the first magnet unit 127 and the second magnet unit 128 may overcome the weight and frictional force of the second door 16, thereby opening the second door 16 with respect to the first door 15.

A space in which the second magnet unit 128 is movable may be defined inside the case 101.

Partition walls 102 and 103 may be arranged on one side in the case 101. The partition walls 102 and 103 may include a first partition wall 102 and a second partition wall 103. The partition walls 102 and 103 may protrude rearward from an inner front surface of the case 101. The first partition wall 102 may extend horizontally in the left-right direction.

The first partition wall 102 may be located at a preset height from the lower surface of the case 101. The first partition wall 102 may be spaced apart in the up-down direction from the upper surface of the case 101 by a preset distance.

The second partition wall 103 may extend vertically upward from one end of the first partition wall 102 toward the upper surface of the case 101. The second partition wall 103 may be arranged toward the driving unit 110.

The first partition wall 102 and the second partition wall 103 may form a single accommodation space together with the upper surface and side surface of the case 101. The second magnet unit 128 may move in the left-right direction by being accommodated in the accommodation space partitioned by the partition walls 102 and 103.

The second magnet unit 128 may move in the left-right direction by receiving the driving force of the driving unit 110 from the first rack 120.

The second magnet unit 128 may be arranged below the first rack 120. The second rack 130 may be integrally connected or detachably connected to one side surface of the second magnet unit 128. This embodiment shows an example in which the second rack 130 is integrally connected to one side surface of the second magnet unit 128.

The second rack 130 may be formed in a rectangular shape. A height of the second rack 130 may correspond to a height of the first magnet holder 1283. The second rack 130 may be connected to the first rack 120 to be in contact with the first rack 120. The second rack 130 is configured to receive the driving force from the first rack 120 and transmit the driving force to the second magnet unit 128.

An operating protrusion 131 may protrude upward from the upper surface of the second rack 130 toward the first rack 120. The operating protrusion 131 may be arranged on one corner of the second rack 130.

The operating protrusion 131 may include a first portion 1311 and a second portion 1312. The first portion 1311 may extend in the front-rear direction. The second portion 1312 may be connected to one side surface of the first portion 1311 and may extend in the left-right direction crossing the first portion 1311.

The first portion 1311 of the operating protrusion 131 may bring the second rack 130 into contact with a portion of the first rack 120, so that the driving force of the first rack 120 can be transmitted to the second rack 130.

The second portion 1312 of the operating protrusion 131 can increase an area of the upper surface of the second rack 130, which supports the operating protrusion 131, thereby reinforcing the strength of the operating protrusion 131. In case that there is no problem with the support strength of the operating protrusion 131, the second portion 1312 may be omitted.

The second portion 1312 of the operating protrusion 131 may also guide the movement of the first rack 120 when being brought into contact with a first contact protrusion 1241 of the first rack 120 to be described later.

A contact portion 124 may protrude downward from the lower surface of the second rack 120 toward the second rack 130. The contact portion 124 may include a first contact protrusion 1241, a second contact protrusion 1242, and a connecting protrusion 1243. The first contact protrusion 1241 may extend in a direction crossing the first rack 120.

For example, the first contact protrusion 1241 may extend in the front-rear direction from the lower surface of the first rack 120. A length of the first contact protrusion 1241 in the front-rear direction may be equal to or smaller than a width of the first rack 120 in the front-rear direction. This embodiment shows an example in which the length of the first contact protrusion 1241 in the front-rear direction is smaller than the width of the first rack 120 in the front-rear direction.

The first contact protrusion 1241 may be selectively brought into contact with the operating protrusion 131 depending on the change in position of the first rack 120. For example, when the first rack 120 is located at a first position, the first contact protrusion 1241 may be brought into contact with the operating protrusion 131. When the first rack 120 is located at a second position, the first contact protrusion 1241 and the operating protrusion 131 may be spaced apart from each other.

Here, the first position defines a position at which the first rack 120 can move as close as possible toward the hinge when the second door 16 is closed. The second position defines a position at which the first rack 120 can move as close as possible toward the locking device 22 when the second door 16 is open.

The second contact protrusion 1242 may extend in a direction crossing the first rack 120. For example, the second contact protrusion 1242 may extend in the front-rear direction from the lower surface of the first rack 120.

A length of the second contact protrusion 1242 in the front-rear direction may be equal to or smaller than a width of the first rack 120 in the front-rear direction. This embodiment shows an example in which the length of the second contact protrusion 1242 in the front-rear direction is equal to the width of the first rack 120 in the front-rear direction.

The second contact protrusion 1242 may be arranged at a preset distance from the first contact protrusion 1241 in the left-right direction. The operating protrusion 1241 may be arranged between the first contact protrusion 1241 and the second contact protrusion 1242. The distance between the first contact protrusion 1241 and the second contact protrusion 1242 may be larger than a width of the first portion 1311 of the operating protrusion 131 in the left-right direction.

The second contact protrusion 1242 may be selectively brought into contact with the operating protrusion 131 depending on the change in position of the first rack 120. For example, when the first rack 120 is located at a second position, the second contact protrusion 1242 may be brought into contact with the operating protrusion 131. When the first rack 120 is located at a first position, the second contact protrusion 1242 and the operating protrusion 131 may be spaced apart from each other.

The first contact protrusion 1241 and the second contact protrusion 1242 may be selectively brought into contact with the operating protrusion 131 depending on the movement direction of the first rack 120.

For example, when the first rack 2 moves in one direction toward the second hinge 132, the first contact protrusion 1241 and the operating protrusion 131 may be brought into contact with each other. When the first contact protrusion 1241 and the operating protrusion 131 begin to come into contact with each other, the driving force of the first rack 120 may be transmitted to the second rack 130. The first rack 120 may move further in the one direction to reach the first position after the first contact protrusion 1241 and the operating protrusion 131 come into contact with each other.

Through this, the second magnet unit 128 can move away from the first magnet unit 127 by the driving force transmitted from the first rack 120 to the second rack 130. When the distance between the first magnet unit 127 and the second magnet unit 128 in the left-right direction is greater than or equal to a preset distance d3, the second door 16 can be closed by the attractive force acting between the magnets.

When the first rack 120 moves in an opposite direction to the one direction toward the locking device 22, the second contact protrusion 1242 and the operating protrusion 131 can come into contact with each other. When the second contact protrusion 1242 and the operating protrusion 131 begin to come into contact with each other, the driving force may be transmitted from the first rack 120 to the second rack 130. The first rack 120 may move further in the opposite direction to the one direction to reach the second position after the second contact protrusion 1242 and the operating protrusion 131 come into contact with each other.

Through this, the second magnet unit 128 can move toward the first magnet unit 127 by the driving force transmitted from the first rack 120 to the second rack 130. When the distance between the first magnet unit 127 and the second magnet unit 128 in the left-right direction is smaller than or equal to a preset distance d1, the second door 16 can be open by the repulsive force acting between the magnets.

The reason why the operating protrusion 131 is arranged to be selectively in contact with or spaced apart from the first contact protrusion 1241 and the second contact protrusion 1242 is to ensure that the first door 15 and the second door 16 are unlocked first and then the second door 16 is open while the first rack 120 moves toward the locking device 22.

This is also to ensure that the locking device 22 is returned to its original position first and then the second door 16 is closed while the first rack 120 moves toward the second hinge 132.

The connecting protrusion 1243 may extend in the left-right direction of the first rack 120. The connecting protrusion 1243 may connect the first contact protrusion 1241 and the second contact protrusion 1242. The length of the connecting protrusion 1243 may define a gap between the first contact protrusion 1241 and the second contact protrusion 1242.

The connecting protrusion 1243 may extend in a direction crossing the first contact protrusion 1241 and the second contact protrusion 1242, thereby reinforcing the supporting force of the second rack 130 for the first contact protrusion 1241 and the second contact protrusion 1242.

The connecting protrusion 1243 may guide the movement of the operating protrusion 131 when being brought into contact with the first portion 1311 of the operating protrusion 131.

FIG. 18 is an enlarged conceptual view of a portion XVIII in FIG. 6, which shows that a third rack 140 is installed in the second door 16.

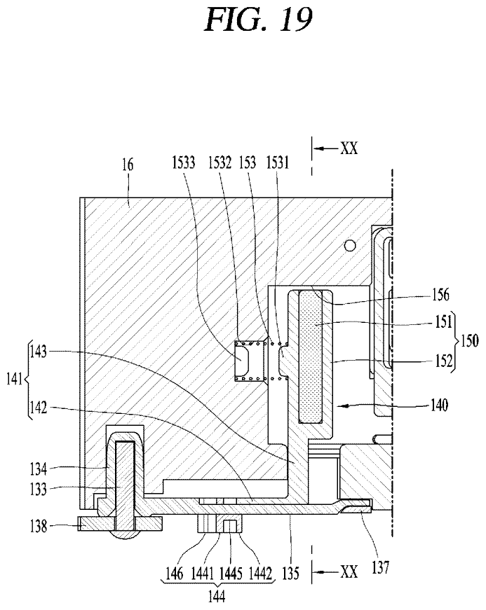

FIG. 19 is a cross-sectional view taken along line XIX-XIX in FIG. 18, which is a conceptual view of a compressed state of an elastic member of the third rack 140 when closing the second door 16.

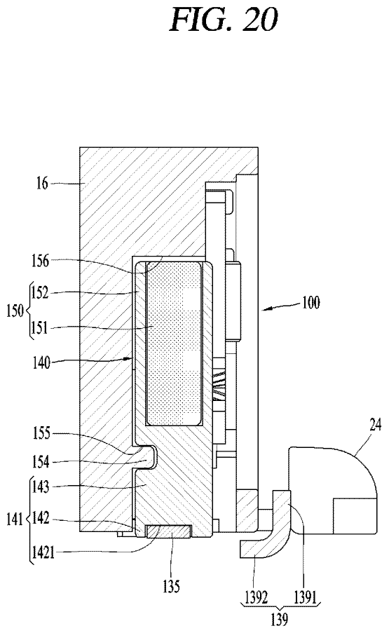

FIG. 20 is a cross-sectional view taken along line XX-XX in FIG. 19, which is a conceptual view showing that the third rack 140 is slidably supported by a side guide protrusion 154.

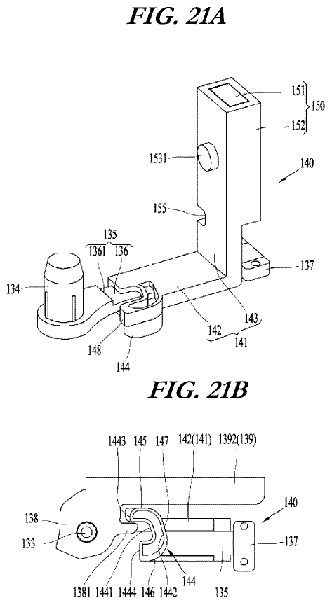

FIG. 21 is a conceptual view of a state in which the third rack 140 is mounted on a hinge coupling portion 135 of a second hinge 132 in FIG. 18.

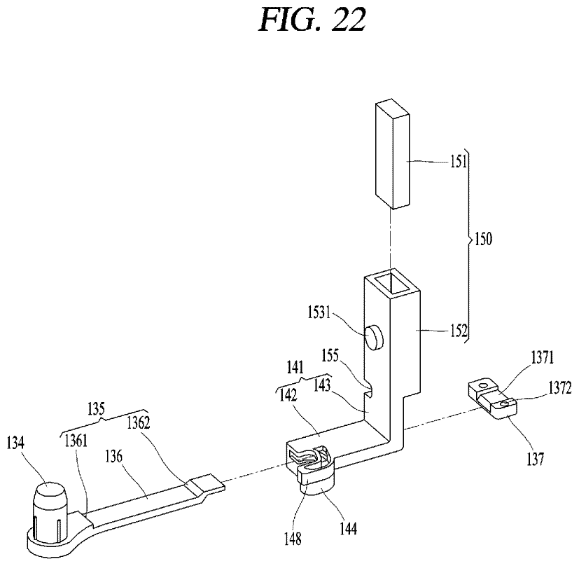

FIG. 22 is an exploded conceptual view of the third rack 140 and the second hinge 132 in FIG. 21.

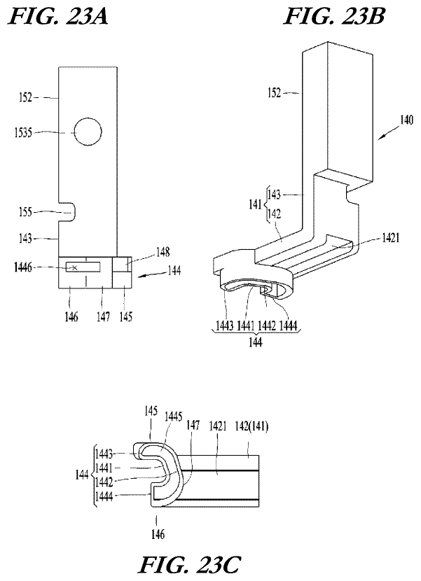

FIG. 23 is a conceptual view of left, right, and lower surfaces of the third rack 140 in FIG. 22.

The second hinge 132 may include a hinge base 138. The hinge base 138 is arranged below the hinge coupling portion 135. The hinge base 138 is arranged on the lower surface of the second door 16. The hinge base 138 may extend along the lower surface of the second door 16.

The hinge base 138 is arranged to overlap a portion of the hinge coupling portion 135 in the up-down direction. A hinge hole 1384 is formed through the hinge base 138 in the up-down direction.

The hinge shaft 133 may pass through the hinge hole 1384 to be coupled to the hinge base 138 and the hinge shaft accommodating portion 134. The hinge shaft 133 may rotate relative to the hinge shaft accommodating portion 134 while being accommodated in the hinge shaft accommodating portion 134. The hinge shaft 133 and the hinge base 138 rotate together.

The hinge shaft accommodating portion 134 and hinge coupling portion 135 may be coupled to the second door 16 so as to rotate together with the second door 16.

The hinge shaft 133 and the hinge base 138 may be coupled to the first door 15 so as to rotate together with the first door 15.

A hinge connecting portion 139 may be arranged on one side of the hinge base 138. The hinge base 138 may be connected to the first door 15 by the hinge connecting portion 139. The hinge connecting portion 139 may extend from one side of the hinge base 138 in the left-right direction of the first door 15. The hinge connecting portion 139 is configured to be coupled to the first door 15.

The hinge connecting portion 139 includes a first plate 1391 and a second plate 1392. The first plate 1391 may extend along the front surface of the first door 15. The first plate 1391 may be vertically arranged to face the front surface of the first door 15 in the front-rear direction. The first plate 1391 may be coupled to the front surface of the first door 15.

The second plate 1392 may extend along the lower surface of the first door 15. The second plate 1392 may be horizontally arranged to face the lower surface of the first door 15 in the up-down direction. The second plate 1392 protrudes forward from a lower end of the first plate 1391.

The second plate 1392 protrudes from the lower end of the first plate 1391 in the left-right direction. The second plate 1392 may be integrally connected to the lower end of the first plate 1391. The second plate 1392 may connect the hinge base 138 and the first plate 1391.

The second plate 1392 may increase the supporting force of the hinge connecting portion 139 for the hinge base 138.

An engaging protrusion 1381 may protrude from the hinge base 138. For example, the engaging protrusion 1381 may protrude in parallel to the hinge connecting portion 139. The engaging protrusion 1381 may protrude from one side of an outer circumferential surface of the hinge base 138 to be in parallel to the front surface of the first door 15.

An engaging groove 1383 may be formed between the engaging protrusion 1381 and the second plate 1392 of the hinge connecting portion 139. A locking hook 144 of the third rack 140, which will be described later, may be locked by being inserted into the engaging groove 1383.

The engaging protrusion 1381 may include a first surface, a second surface, and a third surface. The first surface may be positioned toward the hinge connecting portion 139. The first surface of the engaging protrusion 1381 may form a rear surface of the engaging protrusion 1381.

The second surface of the engaging protrusion 1381 may form a front surface of the engaging protrusion 1381. The second surface of the engaging protrusion 1381 may be arranged toward the front surface of the second door 16. The first and second surfaces of the engaging protrusion 1381 may form a plane.

The third surface of the engaging protrusion 1381 extends to connect one end of the first surface and one end of the second surface. The third surface of the engaging protrusion 1381 may be curved. The third surface of the engaging protrusion 1381 may be formed with a preset curvature.

The curvature of the third surface of the engaging protrusion 1381 may vary depending on a rotation angle of the locking hook 144 of the third rack 140. The curvature of the third surface of the engaging protrusion 1381 may increase from the second surface to the first surface.

The third rack 140 may include the locking hook 144. The locking hook 144 is configured to engage with the engaging protrusion 1381. The locking hook 144 may engage with the engaging protrusion 1381 so as to be locked when the second door 16 is closed. The locking hook 144 may move to be released from the engaging protrusion 1381 so as to be unlocked when the second door 16 is open.

The locking hook 144 may rotate together with the second door 16. The locking hook 144 may be coupled to be rotatable together with the hinge coupling portion 135.

The locking hook 144 may be mounted to be slidable in one direction at the hinge coupling portion 135. The locking hook 144 may be coupled to the hinge coupling portion 135 to be slidable by a hinge slide 141.

The hinge slide 141 may include a first slide 142 and a second slide 143. The first slide 142 may be formed in a rectangular shape. The first slide 142 may extend along the hinge coupling portion 135.

The hinge coupling portion 135 may extend long in one direction such that its length is greater than a width. The hinge coupling portion 135 may be formed in a rectangular plate shape. A thickness of the hinge coupling portion 135 may be defined between upper and lower surfaces of the hinge coupling portion 135.

A mounting portion 136 may be formed at an upper surface of the hinge coupling portion 135. The mounting portion 136 may be recessed from the upper surface to the lower surface of the hinge coupling portion 135. A first step 1361 may be formed on one end of the mounting portion 136 in a longitudinal direction of the mounting portion 136. A second step 1362 may be formed on another end of the mounting portion 136 in the longitudinal direction of the mounting portion 136.

Through this, the first step 1361 and the second step 1362 can limit a distance by which the first slide 142 of the hinge slide 141 can move on the hinge coupling portion 135 according to the change in position of the third rack 140 to be described later.

The first slide 142 may be formed such that its length is larger than a width. The first slide 142 may be formed in a rectangular shape. The length of the first slide 142 may be smaller than the length of the hinge coupling portion 135. The width of the first slide 142 may be larger than the width of the hinge coupling portion 135.

A slide groove 1421 may be formed on a lower surface of the first slide 142. The slide groove 1421 may extend in a penetrating manner along the lower surface of the first slide 142. A width of the slide groove 1421 is formed to correspond to the width of the hinge coupling portion 135. The first slide 142 may be slidably coupled to the mounting portion 136 of the hinge coupling portion 135 through the slide groove 1421.

The first slide 142 may move linearly and reciprocally between the first step 1361 and the second step 1362 of the hinge coupling portion 135.

Through this, the locking hook 144 can be locked to or unlocked from the engaging protrusion 1381 of the second hinge 132 according to the change in rotation angle of the second door 16.

Hereinafter, a detailed configuration of the locking hook 144 will be described. The locking hook 144 may be formed in a shape of a hook. The locking hook 144 may be integrally connected or coupled to one end of the first slide 142 of the hinge slide 141. This embodiment shows an example in which the locking hook 144 is integrally connected to one end of the first slide 142.

The locking hook 144 may include a first wall 1441, a second wall 1442, a third wall 1443, a fourth wall 1444, and a connecting wall 1445. The first wall 1441 through the fourth wall 1444 may each extend in the up-down direction. The first wall 1441 to the fourth wall 1444 may form a single closed curve.

The first wall 1441 and the second wall 1442 may be spaced apart from each other in a longitudinal direction of the first slide 142 or a direction crossing the longitudinal direction of the first slide 142 and may be arranged to face each other. The third wall 1443 may connect one end of the first wall 1441 and one end of the second wall 1442. The fourth wall 1444 may connect another end of the first wall 1441 and another end of the second wall 1442.

The connecting wall 1445 may extend along an inner surface of a closed curve which is formed by the first wall 1441 to the fourth wall 1444. The connecting wall 1445 may connect inner surfaces of the first wall 1441 to the fourth wall 1444. The connecting wall 1445 may protrude horizontally between the first wall 1441 and the second wall 1442.

In order for the first slide 142 of the third rack 140 to be slidable along the hinge coupling portion 135, a through hole 1446 may be formed in one direction through each of the first wall 1441 and the second wall 1442 of the locking hook 144. The through hole 1446 may have the same size as a cross-sectional area the hinge coupling portion 135.

Portions of the first wall 1441 and the second wall 1442 may be integrally connected to one end of the first slide 142. Through this, the locking hook 144 and the first slide 142 can be supported by each other. The locking hook 144 may slide along the hinge coupling portion 135 together with the first slide 142.

A portion of the connecting wall 1445 may be arranged horizontally to be in surface contact with the upper or lower surface of the hinge coupling portion 135. This embodiment shows an example in which the connecting wall 1445 is positioned to be in surface contact with the lower surface of the hinge coupling portion 135.

The locking hook 144 may have a cross-section in the shape of H or h.

The first wall 1441 and the second wall 1442 may correspond to two vertical columns, which face each other on both sides of the H- or h-like cross-section at a preset gap, and the connecting wall 1445 may correspond to a middle section horizontally arranged to connect the two columns.

Through this, the locking hook 144 has an h-like cross-sectional shape, so that the weight of the locking hook 144 can be reduced and the rigidity of the locking hook 144 can be increased.

When viewed from above or below, the locking hook 144 may be divided into a first hook portion 145, a second hook portion 146, and a hook connecting portion 147 depending on the shape of the locking hook 144. The first hook portion 145 may be formed to engage with the engaging protrusion 1381.

The first hook portion 145 may protrude from a rear surface of the first slide 142 toward the hinge connection portion 139 when the second door 16 is closed. When the second door 16 is closed, the first hook portion 145 may be inserted into the engaging groove 1383 formed between the engaging protrusion 1381 and the hinge connecting portion 139 and engage with the engaging protrusion 1381. The first hook portion 145 may extend in the longitudinal direction of the hinge coupling portion 135.

The second hook portion 146 may be arranged to be spaced apart from the first hook portion 145 in the front-rear direction when the second door 16 is closed. The second hook portion 146 may be arranged to be spaced apart from the engaging protrusion 1381 in an opposite direction to the first hook portion 145 with respect to the engaging protrusion 1381 when the second door 16 is closed. The second hook portion 146 may extend from the lower surface of the hinge coupling portion 135 in the longitudinal direction of the hinge coupling portion 135.

The hook connecting portion 147 may extend from the first hook portion 145 to the second hook portion 146 to connect the first hook portion 145 and the second hook portion 146. The hook connecting portion 147 may extend in a direction crossing the longitudinal direction of the hinge coupling portion 135.

Rear and front ends of the hook connecting portion 147 may each have a curved shape having a preset curvature. The rear end of the hook connecting portion 147 may be connected to the first hook portion 145. The front end of the hook connecting portion 1382 may be connected to the second hook portion 146.

The locking hook 144 may further include an upper coupling portion 148. The upper coupling portion 148 may protrude in one direction from an upper portion of the first hook portion 145.

The upper coupling portion 148 may be arranged, together with the first hook portion 145, between the engaging protrusion 1381 and the second plate 1392 of the hinge connecting portion 139 when the second door 16 is closed. A portion of the upper coupling portion 148 may be coupled by being seated on an upper surface of the engaging protrusion 1381 when the second door 16 is closed.

The first hook portion 145 may be coupled in close contact with a side surface of the engaging protrusion 1381 when the second door 16 is closed. A portion of the upper coupling portion 148 may be arranged to overlap the engaging protrusion 1381 in the up-down direction when the second door 16 is closed.

With the configuration, the upper coupling portion 148 can assist the engagement between the engaging protrusion 1381 and the first hook portion 145. The upper coupling portion 148 can increase the engagement force between the engaging protrusion 1381 and the locking hook 144 and stably and firmly maintain the engaged state.

The third rack 140 may move according to the change in position of the first rack 120. The third rack 140 may receive a driving force from the driving unit 110. The third rack 140 may receive the driving force from the driving unit 110 using a magnetic force.

The third rack 140 may include a third magnet unit 150. The third magnet unit 150 may include a fifth magnet 151 and a third magnet holder 152. The fifth magnet 151 may be formed in a rectangular shape. The fifth magnet 151 may extend long in the up-down direction. The fifth magnet 151 may be arranged to face the second magnet unit 128.

At least a portion of the fifth magnet 151 may be arranged to face the third magnet 1281 in one direction. Here, the one direction may mean the left-right direction of the second door 16. The fifth magnet 151 may have the same polarity as the third magnet 1281. For example, the fifth magnet 151 may have an N-pole.

A thickness of the fifth magnet 151 may be formed between first and second surfaces of the fifth magnet 151. The first surface of the fifth magnet 151 may be arranged to face the third magnet 1281. The first surface of the fifth magnet 151 may have the same polarity as the third magnet 1281. The second surface of the fifth magnet 151 may have an opposite polarity to that of the third magnet 1281.

The third rack 140 may further include a sixth magnet. The sixth magnet may be connected continuously to a lower portion of the fifth magnet 151. The sixth magnet may have an opposite polarity to that of the fifth magnet 151. The sixth magnet may have an S-pole. The sixth magnet may be omitted. This embodiment shows an example in which the sixth magnet is omitted.

The third magnet holder 152 includes a magnet accommodating portion to accommodate the fifth magnet 151. For example, the fifth magnet 151 may be magnetized with a single pole. The fifth magnet 151 may have an N-pole.

The third magnet holder 152 may be integrally formed with or coupled to an upper portion of the second slider 143. This embodiment shows an example in which the third magnet holder 152 is integrally formed with the upper portion of the second slider 143.

The third magnet holder 152 may extend in the up-down direction. The third magnet holder 152 may be formed in a rectangular shape. The third magnet holder 152 may be formed long in the up-down direction.

Through this, the fifth magnet 151 of the third magnet unit 150 can exert magnetic interaction, i.e., a repulsive force, on the third magnet 1281 of the second magnet unit 128 according to the change in position of the second rack 130.

The driving force of the driving unit 110 may be transmitted to the third rack 140 through the first rack 120 and the second rack 130.

When the second door 16 is closed, the driving force may be transmitted to the third rack 140. The locking hook 144 of the third rack 140 may move along the hinge coupling portion 135 in a direction toward the engaging protrusion 1381 of the hinge base 138 by the repulsive force. The locking hook 144 may be locked by being engaged with the engaging protrusion 1381.

When the second door 16 is open, the locking hook 144 of the third rack 140 may move along the hinge coupling portion 135 in a direction away from the engaging protrusion 1381 of the hinge base 138 by an elastic force.

The third rack 140 may be elastically supported by a spring 153. The spring 153 may be installed inside the second door 16. The spring 153 may be formed in a coil shape. The spring 153 may return the third magnet unit 150 to an original position when the second door 16 is open.

The fifth magnet 151 may be accommodated between a first side wall and a second side wall of the third magnet holder 152. The first side wall may be arranged toward the second magnet unit 128. The second side wall may be positioned in an opposite direction to the first side wall. The second side wall may be arranged toward the hinge shaft 133.

The first support protrusion 1531 may protrude from the second side wall toward the hinge shaft 133. A first support protrusion 1531 may be formed in a circular shape. The first support protrusion 1531 may be inserted into one end of the spring 153. Through this, the one end of the spring 153 may be supported by the first support protrusion 1531.

A spring support portion 1532 may be formed in the second door 16. The spring support portion 1532 may be recessed at one side of the second door 16 in a protruding direction of the first support protrusion 1531. A second support protrusion 1533 may protrude from an inner surface of the spring support portion 1532 toward the first support protrusion 1531.

The first support protrusion 1531 and the second support protrusion 1533 may protrude in opposite directions to face each other. The second support portion 1533 may be formed in a circular shape. The second support protrusion 1533 may be inserted into another end of the spring 153.

Through this, the other end of the spring 153 can be supported by the second support protrusion 1533.

The third magnet unit 150 is located on an upper portion of the third rack 140. The third magnet unit 150 is positioned higher than the hinge coupling portion 135. The third magnet unit 150 may receive the repulsive force from the second magnet unit 128.

However, the first slide 142 is slidably mounted on the hinge coupling portion 135, but the second slide 143 and the third magnet unit 150 may be lifted upward due to the repulsive force acting on the third magnet unit 150.

To solve this, a side guide protrusion 154 may be arranged inside the second door 16. The side guide protrusion 154 may protrude from the front surface of the second door 16 toward the rear surface of the second door 16. The side guide protrusion 154 may protrude toward the second slide 143.

The side guide protrusion 154 may extend in the left-right direction of the second door 16. The side guide protrusion 154 may be positioned higher than the hinge coupling portion 135. The side guide protrusion 154 may be arranged in parallel to the longitudinal direction of the hinge coupling portion 135.

A side guide groove 155 may be recessed rearward at the front end of the second slide 143. The side guide protrusion 154 may be inserted into the side guide groove 155.

Through this, the second slide 143 can move left and right along the side guide protrusion 154 which is coupled to the side guide groove 155. The second slide 143 of the third rack 140 and the third magnet unit 150 can be suppressed from being lifted upward.

An upward movement restricting portion 156 may be arranged on one side inside the second door 16. The upward movement restricting portion 156 is located above the third magnet unit 150. The upward movement restricting portion 156 extends in the left-right direction of the second door 16. The upward movement restricting portion 156 is arranged to face an upper surface of the third magnet unit 150 in the up-down direction.

The upward movement restricting portion 156 is arranged to be spaced apart from the upper surface of the third magnet unit 150 with a preset gap in between.

The upward movement restricting portion 156 can restrict the third magnet unit 150 from being lifted upward while the third magnet unit 150 moves left and right along the hinge coupling portion 135.

The through hole 1446 is formed through each of the first wall 1441 and the second wall 1442 of the locking hook 144 in the left-right direction. The hinge coupling portion 135 is coupled through the through holes 1446. A through hole may be arranged at the front end of the first slide 142. The second wall 1442 of the locking hook 144 may be formed convexly toward the second slide 143 in the through hole.

Upper portions of the first wall 1441 and the second wall 1442 of the locking hook 144 are located at an upper portion of the through hole and are slidably coupled to the hinge coupling portion 135. Through this, the upper portions of the first wall 1441 and the second wall 1442 of the locking hook 144 can restrict the first slide 142 from being lifted upward.

The lower portions of the first wall 1441 and the second wall 1442 and the connecting wall 1445 of the locking hook 144 are located below the through hole and are slidably coupled to the hinge coupling portion 135. Through this, the lower portions of the first wall 1441 and the second wall 1442 and the connecting wall 1445 of the locking hook 144 can restrict the first slide 142 from being lifted upward.

The third rack 140 may move in one direction by the repulsive force acting between the second magnet unit 128 and the third magnet unit 150 when the second door 16 is closed. The third rack 140 may move in an opposite direction to the one direction by the elastic force of the spring 153 when the second door 16 is open.

Hereinafter, the operating state and function of the door opening and closing device 100 according to the disclosure will be described.

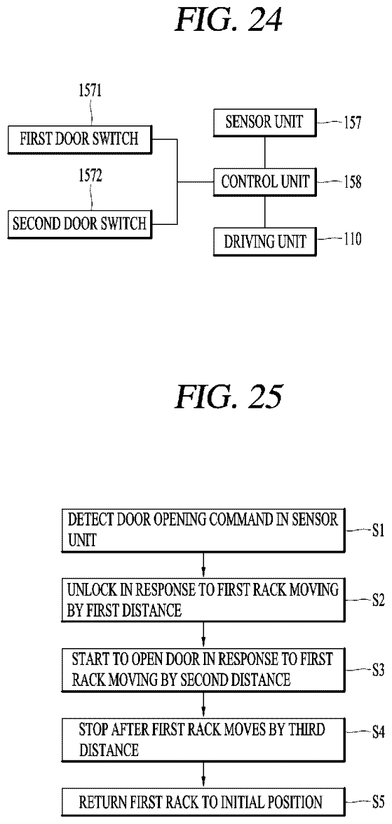

FIG. 24 is a block diagram of a configuration for controlling opening of the second door 16 of the refrigerator according to the embodiment in FIG. 1.

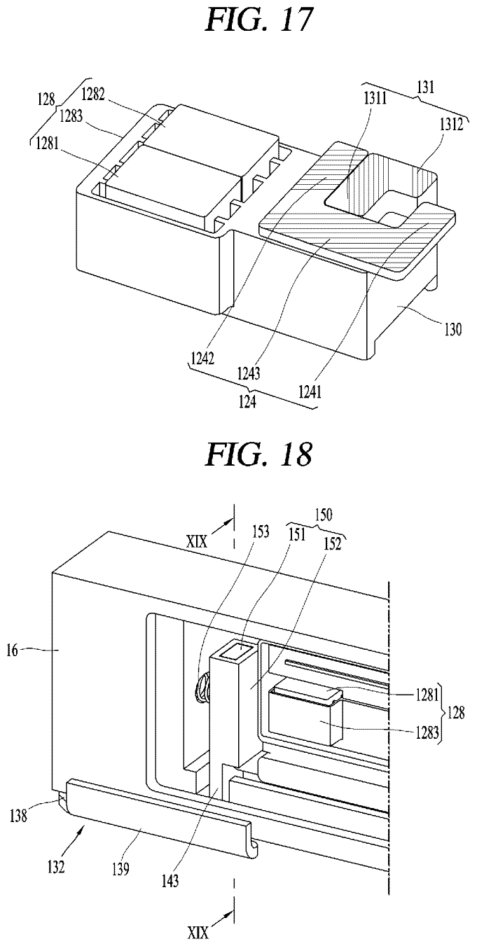

FIG. 25 is a flowchart of sequential operations of the door opening and closing device 100 and the locking device 22 according to a distance by which the first rack 120 moves by the configuration of FIGS. 1 to 24.

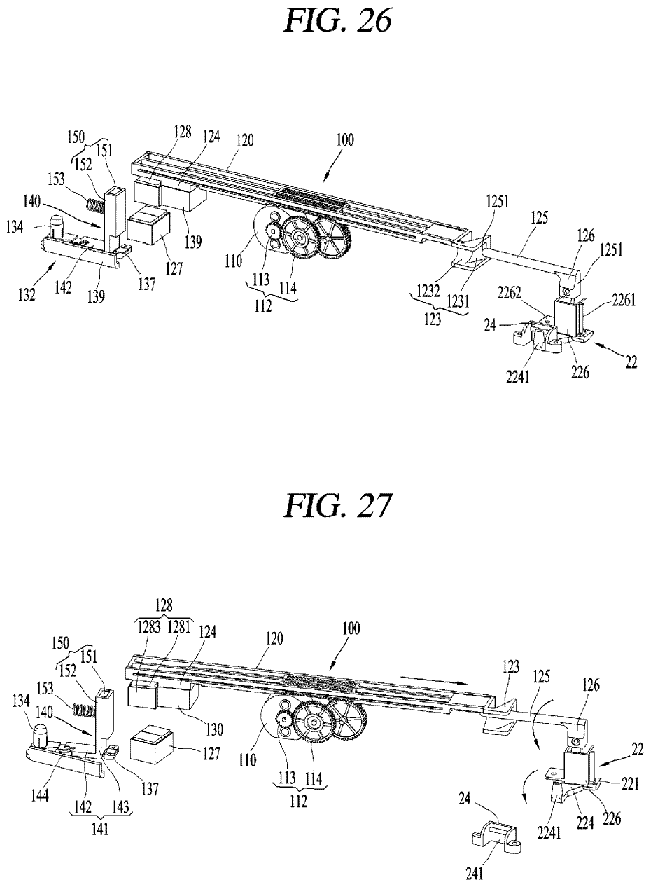

FIG. 26 is a perspective view of the door opening and closing device 100 and the locking device 22 at the first position of the first rack 120 when closing the second door 16, viewed from the rear of the second door 16.

FIG. 27 is a perspective view of the door opening and closing device 100 and the locking device 22 at the second position of the first rack 120 when opening the second door 16, viewed from the rear of the second door 16.

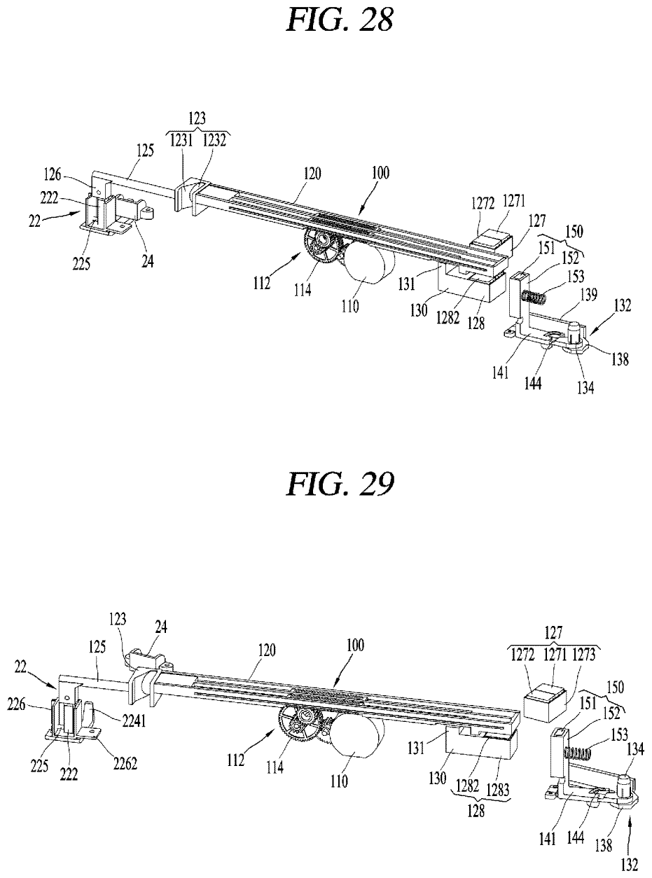

FIG. 28 is a perspective view of the door opening and closing device 100 and the locking device 22 at the first position of the first rack 120 when closing the second door 16, viewed from the front of the second door 16.

FIG. 29 is a perspective view of the door opening and closing device 100 and the locking device 22 at the second position of the first rack 120 when opening the second door 16, viewed from the front of the second door 16.

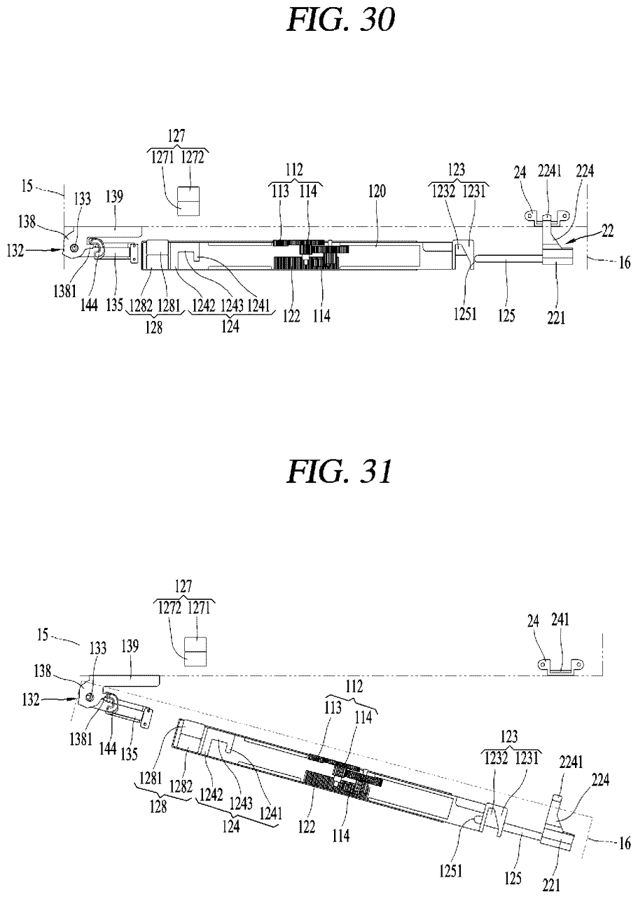

FIG. 30 is a perspective view of the door opening and closing device 100 and the locking device 22 at the first position of the first rack 120 when closing the second door 16, viewed from the bottom of the second door 16.

FIG. 31 is a perspective view of the door opening and closing device 100 and the locking device 22 at the second position of the first rack 120 when opening the second door 16, viewed from the bottom of the second door 16.

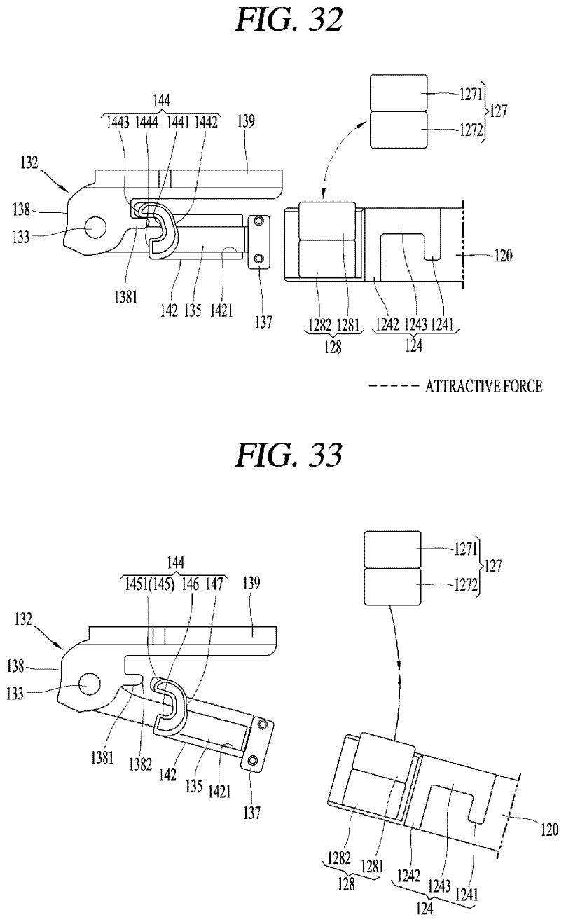

FIG. 32 is a conceptual view of relative positions of the first magnet unit 127, the second magnet unit 128, and the third rack 140 at the first position of the first rack 120 when closing the second door 16 in FIG. 30.

FIG. 33 is a conceptual view of relative positions of the first magnet unit 127, the second magnet unit 128, and the third rack 140 at the second position of the first rack 120 when opening the second door 16 in FIG. 31.

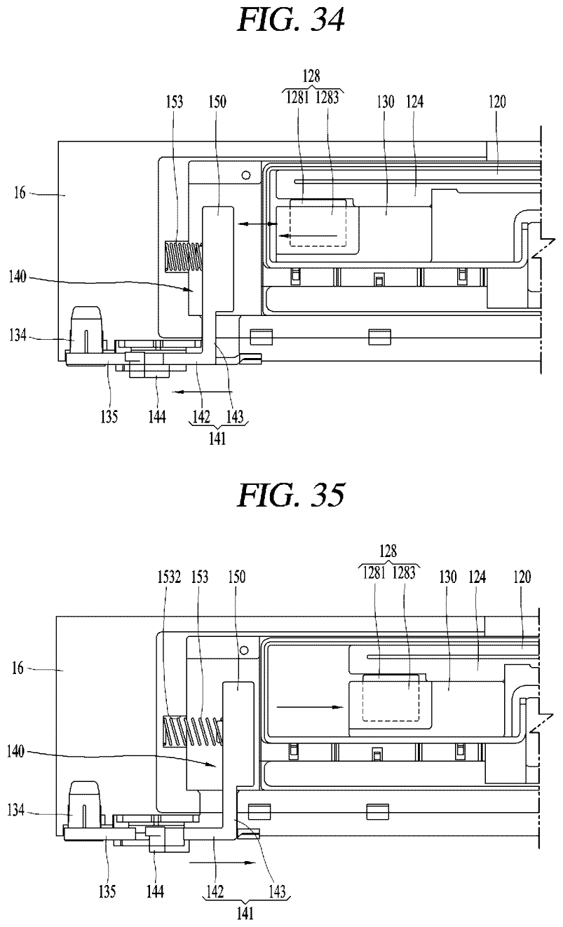

FIG. 34 is a perspective view of repulsive force between the second magnet unit 128 and the third magnet unit 150 at the first position of the first rack 120 when closing the second door 16 in FIG. 18.

FIG. 35 is a perspective view of positions between the second magnet unit 128 and the third magnet unit 150 at the second position of the first rack 120 when opening the second door 16 in FIG. 34.

In this embodiment, the refrigerator may further include a control unit 158. The control unit 158 may be installed on or spaced from an object to be controlled. The control unit 158 may be located inside the object to be controlled or outside the object to be controlled.

For example, the control unit 158 may be arranged in the cabinet 10 or in the refrigerating chamber door 13.

The control unit 158 may include the driving unit 110. The control unit 158 may be located outside the driving unit 110. The control unit 158 may control the driving unit 110 alone, or may control other components in the refrigerator in addition to the driving unit 110.

The second door 16 may include a sensor unit 157. The sensor unit 157 may detect an input of a door opening command for opening the second door 16. The sensor unit 157 may be implemented as any one sensor selected from a touch sensor, a knock sensor, an electrostatic capacity sensor, a vibration sensor, and a sound wave detection sensor. The touch sensor may be configured to detect when a user touches the front surface of the second door 16 with a portion of a body, such as a hand. The knock sensor may be configured to detect a plurality of knocks applied to the front surface of the second door 16. The sensor unit 157 may include a mechanical switch or a switch which is operated by pressure.

As another example, the sensor unit 157 may be arranged on the cabinet 10, the first door 15, or the freezing chamber door 14.

The second door 16 may be open manually.

Even when the sensor unit 157 does not detect an input of a door opening command, the user may activate the locking device 22 to manually open the second door 16.

The locking device 22 may be operated independently while the first rack 120 is positioned at the first position. Accordingly, when the user presses the operating unit 221 of the locking device 22 in one direction, for example, upward, the locking device 22 rotates in an unlocking direction. Through this, the locking device 22 can move from the lock position to the unlock position.

Then, the engagement between the latch hook 2241 of the locking device 22 and the engaging wall 241 of the first door 15 may be released. In this state, the user may open the second door 16 by rotating the second door 16. During the manual movement process of the locking device 22, the first rack 120 and the second magnet unit 128 may be maintained in a stationary state.

Hereinafter, an automatic opening operation mode of the second door 16 will be described.

The second door 16 may be open automatically.

In a state where the first door 15 and the second door 16 are closed and locked, when a door opening command is detected by the sensor unit 157 (S1), the control unit 158 may control the driving unit 110 to automatically open the second door 16.

In this embodiment, the operation of the driving unit 110 for opening the second door 16 may be performed while the first door 15 is closed. Opening and closing of the first door 15 may be detected by a first door switch 1571. The first door switch 1571 may be arranged on the cabinet 10 or the first door 15.

The operation of the driving unit 110 for opening the second door 16 may be performed while the second door 16 is closed. Opening and closing of the second door 16 may be detected by a second door switch 1572. The second door switch 1572 may be arranged on the first door 15 or the second door 16.

The control unit 158 may rotate the motor of the driving unit 110 in one direction (for example, clockwise). When the motor rotates in the one direction, the driving force of the driving unit 110 may be transmitted to the first rack 120 through the driving force transmission unit 112.

In more detail, the driving force of the motor of the driving unit 110 is transmitted to the first gear 113 which is connected to the rotary shaft of the motor. The first gear 113 rotates, and the plurality of second gears 114 engaged with the first gear 113 also rotate.

A rotation speed of the motor decreases according to the gear ratio between the first gear 113 and the second gear 114, but a torque generated from the motor increases. Among the plurality of second gears 114, one second gear 114 which ultimately transmits the driving force may be engaged with the rack gear 122 of the first rack 120, so that the torque can be transmitted to the rack gear 122 through the corresponding second gear 114.

The second gear 114 has gear teeth which are formed in a circumferential direction on an outer circumferential surface of a pinion gear. The rack gear 122 has gear teeth which are continuously formed along a horizontal direction. The gear teeth of the rack gear 122 are engaged with the gear teeth on the upper side of the second gear 114.

Through this, a rotational motion of the second gear 114 is converted into a linear motion of the rack gear 122, and the first rack 120 moves linearly toward the locking device 22 together with the rack gear 122 at a first position. Here, the first position means a position of the first rack 120 in the state where the second door 16 is closed and the first door 15 and the second door 16 are in the locked state.

Next, the first contact surface 1231 of the cam 123 which is arranged one end of the first rack 120 at the first position is in contact with the contact end 1251 of the rotary bar 125. When the first rack 120 moves horizontally by a first distance and pushes the contact end 1251 of the rotary bar 125, the contact end 1251 of the rotary bar 125 may rotate forward along the inclined first contact surface 1231.

Here, the first distance refers to a distance of the second door 16 om the left-right direction between the starting and ending points of contact between the first contact surface 1231 and the rotary bar 125. The first contact surface 1231 is inclined forward with respect to the left-right direction of the second door 16 at the starting point of contact.

Continuing, the upper end of the latch bar 222 of the locking device 22 which is coupled to the rotary bar 125 rotates forward together with the rotary bar 125 around the hinge pin 225. The latch 224 coupled to the lower end of the latch bar 222 of the locking device 22 rotates rearward around the hinge pin 225. The latch hook 2241 formed on the front end of the latch 224 moves to the unlock position and is unlocked from the engaging wall 241 of the first door 15.

In the process of the first rack 120 moving from the first position by the first distance in a first direction, the first door 15 and the second door 16 may be unlocked (S2). Here, the first direction refers to a right direction from the second hinge 132 toward the locking device 22 (based on FIG. 26).

At the first position of the first rack 120, the second contact protrusion 1242 of the first rack 120 may be spaced apart from the operating protrusion 131 of the second rack 130. In the process that the first rack 120 moves in the first direction toward the locking device 22 to open the second door 16, the second contact protrusion 1242 may come close to the operating protrusion 131.

Before the second contact protrusion 1242 is brought into contact with the operating protrusion 131, the moving force of the first rack 120 is not transmitted to the operating protrusion 131. Therefore, the second magnet unit 128 remains stationary.

In the state where the first rack 120 has moved from the first position by the first distance, the contact end 1251 of the rotary bar 125 may be located at a boundary between the first contact surface 1231 and the second contact surface 1232 or may be in contact with the second contact surface 1232.

In the state where the first rack 120 has moved from the first position by the first distance, the second contact protrusion 1242 and the operating protrusion 131 may be in contact with each other. Through this, the driving force of the first rack 120 can be transmitted to the second rack 130.

When the first rack 120 moves from the first position by a second distance, the opening of the second door 16 may begin (S3). The second distance is larger than the first distance. In the process in which the first rack 120 moves from the first position by the second distance, the contact between the rotary bar 125 and the second contact surface 1232 may be maintained while the rotary bar 125 is accommodated in the second contact surface 1232, thereby maintaining the rotation angle of the rotary bar 125.

When the first rack 120 moves from the first position by the second distance, the second rack 130 moves together with the first rack 120 while the second contact protrusion 1242 of the first rack 120 and the operating protrusion 131 of the second rack 130 are in contact. The second magnet unit 128 connected to the second rack 130 may move together with the second rack 130.

When the first rack 120 moves from the first position by the second distance, the second rack 130 moves in a direction away from the third rack 140. The second magnet unit 128 moves away from the third magnet unit 150. Through this, the repulsive force acting between the third magnet 1281 of the second magnet unit 128 and the fifth magnet 151 of the third magnet unit 150 is reduced.

Accordingly, the third rack 140 can move toward the second magnet unit 128 by the elastic force of the spring 153 which elastically supports the third magnet unit 150. The third magnetic unit 150 of the third rack 140 is spaced apart from the second magnetic unit 128 with a gap in between.

When the first rack 120 moves from the first position by the second distance, the locking hook 144 of the third rack 140 moves from the engaging groove 1383 of the hinge base 138 toward the second magnet unit 128, unlocking the locking hook 144 and the engaging protrusion 1381.

In the state where the first rack 120 is positioned at the first position, the first magnet 1271 and the third magnet 1281 may be arranged so as not to overlap in the front-rear direction.

At the first position, the attractive force may be applied between the first magnet unit 127 and the second magnet unit 128, so that the second door 16 can be maintained in a closed state. For example, lines of magnetic force may be connected between the first magnet 1271 and the third magnet 1281, and lines of magnetic force may be connected between the second magnet 1272 and the fourth magnet 1282, generating the attractive force.

When the first rack 120 is positioned at the first position, a distance d5 (see FIG. 13) between centers of the second magnet 1272 and the third magnet 1281 may be the maximum distance.

In the process in which the first rack 120 moves from the first position by the second distance, the distance d4, d3 between the second magnet 1272 and the third magnet 1281 may decrease. The attractive force may be generated between the first magnet unit 127 and the second magnet unit 128 until the distance between the centers reaches a first reference distance d3.

Before the distance between the centers reaches the first reference distance d3, the first magnet 1271 and the third magnet 1281 may be arranged to overlap in the front-rear direction. (c) of FIG. 14 shows the relative positions of the first magnet unit 127 and the second magnet unit 128 when the distance between the centers reaches the first reference distance d3.

When the distance between the centers is smaller than the first reference distance d3, the repulsive force is generated between the first magnet unit 127 and the second magnet unit 128 (the attractive force also coexists).

However, even if the repulsive force is generated, the second door 16 may be open only when the repulsive force reaches a reference value. For example, the second door 16 may be open by taking into consideration the weight of the second door 16 itself and the weight of food stored in the second door 16.

(d) and (e) of FIG. 14, when the distance between the centers is smaller than or equal to the first reference distances d1 and do, the number of closed curves among the lines of magnetic force increases, thereby increasing the repulsive force.

For example, as shown in (e) of FIG. 18, when the first rack 120 moves by the second distance, the repulsive force becomes greater than or equal to the reference value, and automatic opening of the second door 16 may begin.

The first rack 120 may stop after moving from the first position by a third distance during the process of opening the second door 16. Here, the third distance is greater than the second distance. The first rack 120 may stop at the second position (S4).

The second door 16 may be automatically open by the repulsive force between the first magnet unit 127 and the second magnet unit 128.

The first magnet unit 127 and the second magnet unit 128 are permanent magnets. Therefore, when the position of one of the first magnet unit 127 and the second magnet unit 128 does not change, the polarities of the first magnet unit 127 and the second magnet unit 128 do not change according to the lapse of time.

When the second door 16 is closed, the relative positions of the first magnet unit 127 and the second magnet unit 128 must change.

To this end, in this embodiment, the driving force of the motor may be used to move the first rack 120 and may be transmitted to the second magnet unit 128 through the second rack 130, so that the first rack 120 can return to its initial position or move toward the first position (S5). The second magnet unit 128 may move away from the first magnet unit 127.

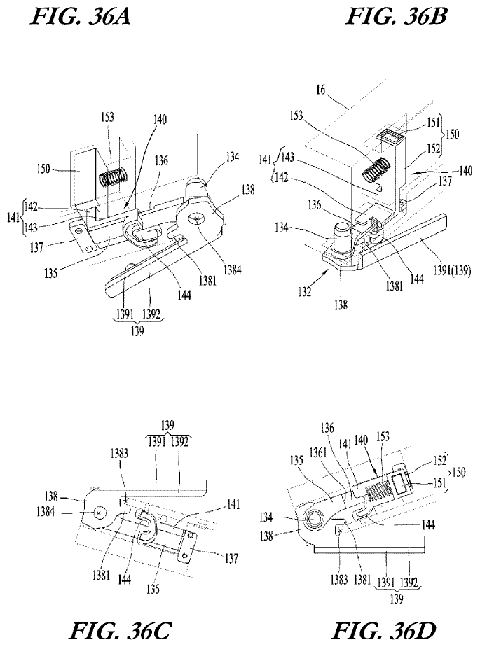

FIG. 36 is a conceptual view, viewed at various angles, of an unlocked state of the third rack 140 at the second position of the first rack 120 when opening the second door 16.

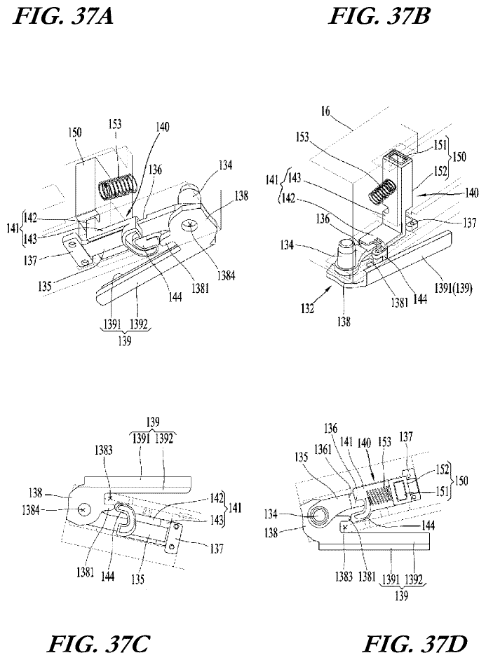

FIG. 37 is a conceptual view, viewed at various angles, of a state before the locking hook 144 of the third rack 140 and the engaging protrusion 1381 of the second hinge 132 are brought into contact with each other during rotation of the second door 16 from an open state to a closed state.

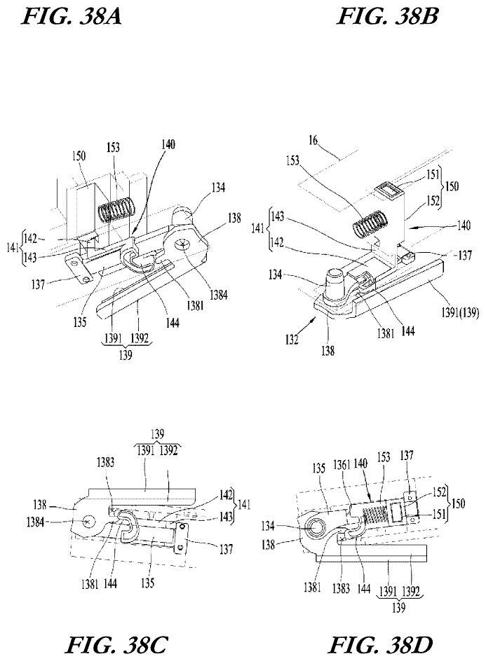

FIG. 38 is a conceptual view, viewed at various angles, of a state before the locking hook 144 of the third rack 140 and the engaging protrusion 1381 of the second hinge 132 are brought into contact and begin to engage with each other during the rotation of the second door 16 from the open state to the closed state.

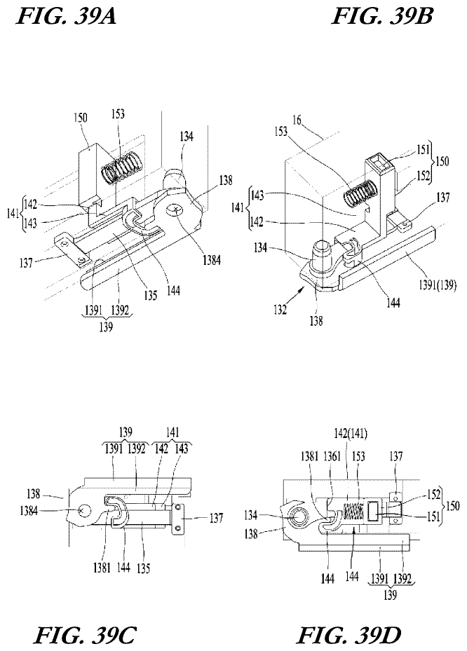

FIG. 39 is a conceptual view, viewed from various angles, of a state in which the locking hook 144 of the third rack 140 and the engaging protrusion 1381 of the second hinge 132 have engaged with each other at the first position of the first rack 120 when the second door 16 is closed.

Hereinafter, auto-closing of the door opening and closing device 100 according to the embodiment will be described.

When the first door 15 is in the closed state and an open angle between the first door 15 and the second door 16 is smaller than or equal to a reference angle, the second door 16 may be automatically closed. The open angle between the first door 15 and the second door 16 may be detected by the sensor unit 157 which is installed on each of the first door 15 and the second door 16.

For example, the sensor unit 157 may include a magnetic field sensor installed in the first door 15 and a magnet installed in the second door 16. As another example, the magnet may be installed in the first door 15 and the magnetic field sensor may be installed in the second door 16. The magnetic field sensor may detect the magnitude of a magnetic field when a distance from the magnet is in a preset range.

Through this, the control unit 158 can receive a detection signal of the sensor unit 157 and determine whether the open angle between the first door 15 and the second door 16 is smaller than or equal to the reference angle.

The control unit 158 may control the driving unit 110 to close the second door 16. For example, the control unit 158 may rotate the motor of the driving unit 110 in an opposite direction (counterclockwise) to the one direction.

A rotational force of the motor is transmitted from the first gear 113 to the plurality of second gears 114. The rotational force is transmitted to the rack gear 122. The rack gear 122 engages with a second gear 114, which ultimately transmits a driving force, among the plurality of second gears 114. At this time, the rotational motion of the second gear 114 is converted into the linear motion of the rack gear 122.

The first rack 120 moves in the second direction. The second direction is opposite to the first direction, and is a direction from the second position toward the first position to be away from the locking device 22. The cam 123 moves in the second direction together with the first rack 120. The second contact surface 1232 of the cam 123 slides relative to the rotary bar 125.

As the cam 123 moves away from the contact end 1251 of the rotary bar 125, the contact end 1251 of the rotary bar 125 may be separated from the second contact surface 1232 of the cam 123. The contact end 1251 of the rotary bar 125 may slide along the inclined first contact surface 1231 of the cam 123 and rotate to the initial position of the first contact surface 1231.

The upper end of the latch bar 222 of the locking device 22 may rotate around the hinge pin 225 together with the rotary bar 125. The latch hook 2241 arranged on the lower end of the latch bar 222 may be rotated to the lock position by being caught on the engaging wall 241 of the first door 15.

In the process in which the first rack 120 moves from the second position in the second direction, the second contact protrusion 1242 of the first rack 120 may be spaced apart from the operating protrusion 131 of the second rack 130, and the first contact protrusion 1241 may be brought into contact with the operating protrusion 131. Before the first contact protrusion 1241 and the operating protrusion 131 are brought into contact with each other, the driving force of the motor is not transmitted from the first rack 120 to the second magnet unit 128 of the second rack 130.

After the first contact protrusion 1241 and the operating protrusion 131 are brought into contact with each other, the driving force of the motor may be transmitted from the first rack 120 to the second rack 130.

With the first contact protrusion 1241 and the operating protrusion 131 in contact, the second magnet unit 128 of the second rack 130 may receive the driving force from the first rack 120 and move away from the first magnet unit 127.

When the distance between the centers of the first magnet unit 127 and the second magnet unit 128 increases by more than the first reference distance d3, the attractive force acts between the first magnet unit 127 and the second magnet unit 128.

For example, as shown in FIG. 13, as the distance between the centers of the first magnet unit 127 and the second magnet unit 128 increases from d3 to d5, the attractive force between the first magnet unit 127 and the second magnet unit 128 may increase.

Through this, the second door 16 can be automatically closed on the first door 15 by the attractive force acting between the first magnet unit 127 and the second magnet unit 128.

With the first contact protrusion 1241 and the operating protrusion 131 in contact, the second magnet unit 128 of the second rack 130 may receive the driving force from the first rack 120 and move in a direction toward the third rack 140.

When the distance between the second magnet unit 128 and the third magnet unit 150 becomes smaller than or equal to the second reference distance, the repulsive force is generated between the second magnet unit 128 and the third magnet unit 150.

The first slide 142 of the third rack 140 may move by the repulsive force acting between the second magnet unit 128 and the third magnet unit 150. The first slide 142 of the third rack 140 moves along the hinge coupling portion 135 toward the hinge shaft 133.

The third magnet unit 150 moves toward the hinge shaft 133 at a distance from the second magnet unit 128, together with the first slide 142 of the third rack 140, due to the repulsive force with the second magnet unit 128. The spring 153 which elastically supports the third magnet unit 150 is compressed.

The locking hook 144 of the third rack 140 is inserted into the engaging groove 1383, which is formed between the engaging protrusion 1381 of the hinge base 138 and the second plate 1392 of the hinge connecting portion 139, by the repulsive force acting between the second magnet unit 128 and the third magnet unit 150. The locking hook 144 may be coupled by engaging with the engaging protrusion 1381.

Through this, the locking hook 144 of the third rack 140 can be automatically locked to or unlocked from the engaging protrusion 1381 of the hinge base 138. Here, the locking hook 144 of the third rack 140 is coupled to the second door 16 through the hinge shaft 133 by the hinge coupling portion 135. The engaging protrusion 1381 of the hinge base 138 is connected to the first door 15 through the hinge shaft 133 by the hinge connecting portion 139.

Accordingly, the second door 16 can be automatically locked to or unlocked from the first door 15 through the third rack 140, which is slidably coupled along the hinge coupling portion 135 of the second hinge 132.

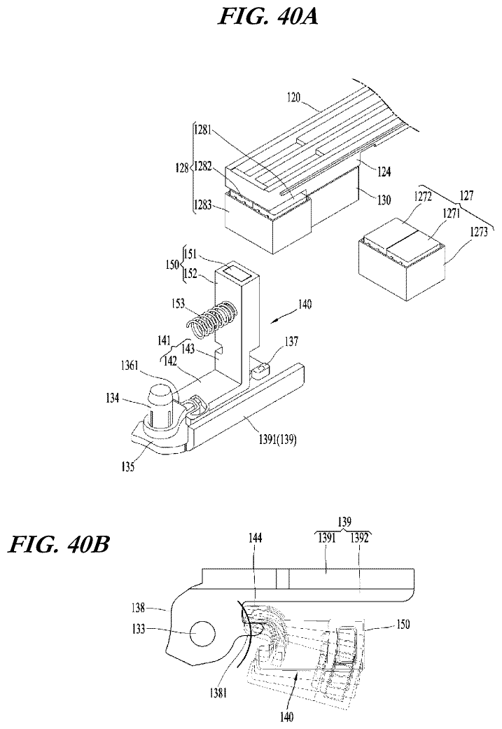

FIG. 40 is a conceptual view for explaining a problem that occurs when the third rack 140 does not slide and the second door 16 rotates during the opening and closing operation of the second door 16.

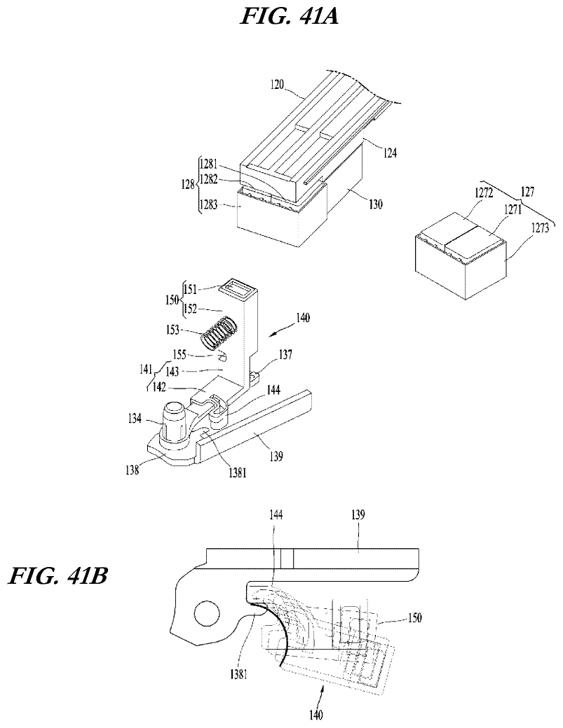

FIG. 41 is a conceptual view of the sliding motion of the third rack 140 in the left-right direction and the rotation of the second door 16 in the front-rear direction which are performed simultaneously during the opening and closing operation of the second door 16.

In this embodiment, the third rack 140 may slide left and right according to the change in position of the first rack 120 during the opening and closing operation of the second door 16.

For example, when the first rack 120 is located at the first position during closing of the second door 16, the first slide 142 of the third rack 140 may be positioned in close contact with the first step 1361 of the hinge coupling portion 135 by the repulsive force between the second magnet unit 128 and the third magnet unit 150.

When the second rack 130 is located at the second position during opening of the second door 16, the first slide 142 of the third rack 140 may be positioned in close contact with the second step 1362 of the hinge coupling portion 135 by the elastic force of the spring 153.

The third rack 140 may rotate forward and backward along with the rotation of the hinge coupling portion 135 during the opening and closing operation of the second door 16.

However, as shown in FIG. 40, if the third rack 140 is fixed without sliding left and right while in close contact with the first step 1361 during the process of opening or closing the second door 16, the following problems may occur.

First, during the process of opening or closing the second door 16, the locking hook 144 may cause friction or interference due to engagement with the engaging protrusion 1381 when rotating forward and backward around the hinge shaft 133.

Second, during the process of opening or closing the second door 16, the locking hook 144 may cause wear due to the friction with the engaging protrusion 1381 when rotating forward and backward around the hinge shaft 133.

As the opening and closing frequency of the second door 16 increases, repeated friction between the locking hook 144 and the engaging protrusion 1381 may cause component damage due to wear of the locking hook 144 and the engaging protrusion 1381.

During the process of opening or closing the second door 16, the locking hook 144 may interfere with the engaging protrusion 1381 when rotating forward and backward around the hinge shaft 133, thereby causing a collision with the engaging protrusion 1381.

Due to this, the user may feel resistance against the first and second doors 16 when opening and closing the second door 16. Even, the lock hook 144 and the engaging protrusion 1381 may mutually engage with each other, making the opening and closing operation of the second door 16 impossible.

To solve these problems, in this embodiment, the third rack 140 to which the locking hook 144 is connected may be connected to be movable along the hinge coupling portion 135 by the elastic force of the spring 153.

When the second door 16 is closed, the first hook portion 145 of the locking hook 144 may be inserted into the engaging groove 1383 to be brought into contact with the engaging protrusion 1381.

The first hook portion 145 of the locking hook 144 may form the first wall 1441 to be in contact with one side surface of the engaging protrusion 1381. A flat portion may be formed in a flat shape on one side surface of the first wall 1441 of the first hook portion 145 to be in surface contact with the one side surface of the engaging protrusion 1381.

Through this, the flat surface of the first hook portion 145 of the locking hook 144 and the one surface of the engaging protrusion 1381 may be in surface contact with each other, so that the locked state of the first door 15 and the second door 16 can be firmly maintained.

Even when the user opens the second door 16 by manual operation, the first hook portion 145 of the locking hook 144 is rotated and inclined relative to the one side surface of the engaging protrusion 1381.

Accordingly, the first hook portion 145 of the locking hook 144 can elastically press the spring 153 toward the third magnet unit 150, so that the locking hook 144 can be separated from the engaging groove 1383 and smoothly unlocked while minimizing resistance against the engaging protrusion 1381.

The second door 16 can be open automatically by the user applying a door opening command, such as knocking, on the second door 16. The control unit 158 may control the driving unit 110 such that the first rack 120 moves from the first position to the second position and then stops.

In this case, before the second door 16 is open by the repulsive force between the first magnet unit 127 and the second magnet unit 128, for example, before the distance between the centers of the second magnet unit 128 and the first magnet unit 127 reaches the first reference distance, the second magnet unit 128 may move in a direction away from the third magnet unit 150 during the process in which the first rack 120 moves from the first position by a distance greater than or equal to the first distance and smaller than the second distance.

Accordingly, the repulsive force between the second magnet unit 128 and the third magnet unit 150 can be released, so that the third rack 140 can move toward the second magnet unit 128 of the second rack 130 by the elastic force of the spring 153.

The first hook portion 145 of the locking hook 144 can be separated from the engaging groove 1383 while minimizing resistance against the engaging protrusion 1381.

In another example, in case that the user closes the second door 16, when the second door 16 rotates toward the first door 15 around the hinge shaft 133 of the second hinge 132, the open angle between the second door 16 and the first door 15 may decrease.

When an open angle detected by the sensor unit 157 is smaller than or equal to a reference angle, the control unit 158 may receive a detection signal from the sensor unit 157 and control the driving unit 110 to move the first rack 120 in the second direction from the second position toward the first position.

With the first contact protrusion 1241 of the first rack 120 and the operating protrusion 131 of the second rack 130 in contact, the second rack 130 may move toward the third rack 140. The second magnet unit 128 of the second rack 130 may be brought closer to the third magnet unit 150 of the third rack 140. The repulsive force may act between second magnet unit 128 and the third magnet unit 150, so that the third magnet unit 150 can overcome the elastic force of the spring 153 and move toward the hinge shaft 133.

The first slide 142 of the third rack 140 may move from the second step 1362 to the first step 1361 along the hinge coupling portion 135 by the repulsive force applied by the third magnet unit 150.

The locking hook 144 of the third rack 140 may perform a rotational motion along the second door 16 while performing a linear motion along the hinge coupling portion 135 toward the engaging protrusion 1381 of the hinge base 138.

As shown in FIG. 41, the locking hook 144 of the third rack 140 may rotate and move along a certain trajectory by the linear motion of the first slide 142 and the rotational motion of the hinge coupling portion 135, so that the locking hook 144 and the engaging protrusion 1381 can engage with each other and also may be automatically locked and unlocked.

Wear which is caused by friction during locking and unlocking of the locking hook 144 and the engaging protrusion 1381 can be minimized, and the resistance of the door during the opening and closing operation of the second door 16 can be minimized.

Component damage caused by the interference between the locking hook 144 and the engaging protrusion 1381 when opening and closing the second door 16 can be minimized.

In some embodiments, when the user manually closes the second door 16 after the second door 16 is open and then the first rack 120 returns to the first position as its initial position, the first slide 142 of the third rack 140 may be brought into close contact with the first step 1361 of the hinge coupling portion 135.

Due to this, as shown in FIG. 40, the first hook portion 145 of the locking hook 144 may rotate together with the second door 16 toward the engaging protrusion 1381 while the first slide 142 of the third rack 140 is in close contact with the first step 1361, and thereby the locking hook 144 and the engaging protrusion 1381 may interfere with each other during the closing process of the second door 16 before the locking hook 144 and the engaging protrusion 1381 engage with each other.

The locking hook 144 of the third rack 140 according to the embodiment may form a first curved portion 1451 on the third wall 1443 of the first hook portion 145 which faces the other side surface of the engaging protrusion 1381. The third wall 1443 is formed to connect one end of the first wall 1441 and one end of the second wall 1442 of the first hook portion 145.

The first curved portion 1451 may be curved with a preset curvature. A second curved portion 1382 having a preset curvature may be formed on the other side surface of the engaging protrusion 1381.

The first curved portion 1451 of the first hook portion 145 of the locking hook 144 and the second curved portion 1382 of the engaging protrusion 1381 may be arranged in opposite directions along the extension direction of the hinge coupling portion 135 when the second door 16 is closed.

When the first curved portion 1451 of the locking hook 144 and the second curved portion 1382 of the engaging protrusion 1381 come into contact and interfere with each other just before the second door 16 is closed, the first curved portion 1451 overcomes the repulsive force between the second magnet unit 128 and the third magnet unit 150 and slides in a direction away from the second curved portion 1382.

Here, when the first curved portion 1451 and the second curved portion 1382 interfere with each other, the attractive force between the first magnet unit 127 and the second magnet unit 128, which is applied to close the second door 16, acts as a rotational moment on the locking hook 144 which is trying to rotate around the hinge shaft 133. The rotational moment may act as a driving force to cause the third rack 140 to slide along the hinge coupling portion 135 from the first step 1361 toward the second step 1362 due to a contacted shape between the first curved portion 1451 and the second curved portion 1382. The driving force by the rotational moment and the elastic force of the spring 153 may be greater than the repulsive force between the second magnet unit 128 and the third magnet unit 150.

Accordingly, when the second door 16 is manually closed after the first rack 120 has returned to the initial position, the locking hook 144 can overcome the repulsive force between the second magnet unit 128 and the third magnet unit 150 by the elastic force of the spring 153 and move away from the engaging protrusion 1381 even though the first curved portion 1451 of the locking hook 144 and the second curved portion 1382 of the engaging protrusion 1381 interfere with each other. This can release the interference between the locking hook 144 and the engaging protrusion 1381.

While the interference between the locking hook 144 and the engaging protrusion 1381 is released, the locking hook 144 can be inserted into the engaging groove 1383 by the repulsive force between the second magnet unit 128 and the third magnet unit 150, thereby engaging with the engaging protrusion 1381.

What is claimed is:

1. A refrigerator comprising:
a cabinet having a storage chamber;
a first door rotatably coupled to the cabinet by a first hinge;
a second door coupled to the first door by a second hinge to be rotatable relative to the first door; and
a door opening and closing device installed inside the second door and configured to automatically open and close the second door,
wherein the second hinge comprises:
a hinge shaft coupled to one surface of the second door to serve as a central shaft for rotation of the second door;
a hinge shaft accommodating portion accommodating the hinge shaft and mounted to be rotatable relative to the hinge shaft;
a hinge coupling portion extending from the hinge shaft accommodating portion in a radial direction of the hinge shaft and coupled to the second door to be rotatable around the hinge shaft;
a hinge base surrounding the hinge shaft and connected to the first door;
an engaging protrusion protruding from one side of the hinge base; and
a locking hook mounted to be reciprocally movable along the hinge coupling portion by an operation of the door opening and closing device, and locked to engage with the engaging protrusion or unlocked from the engaging protrusion when the second door is open or closed.

2. The refrigerator of claim 1, wherein the hinge base is arranged to overlap one surface of the second door in an axial direction of the hinge shaft,
the second hinge comprises a hinge connecting portion extending in one direction from the hinge base and connected to the first door, and
the engaging protrusion protrudes with a gap from the hinge connecting portion in an extension direction of the hinge connecting portion.

3. The refrigerator of claim 1, wherein the door opening and closing device comprises:
a driving unit;
a first magnet unit installed inside the first door; and
a second magnet unit installed in the second door to be movable in a direction toward or away from the first magnet unit by receiving a driving force from the driving unit, the door opening and closing device automatically opening and closing the second door by a magnetic force acting between the first magnet unit and the second magnet unit.

4. The refrigerator of claim 3, wherein the door opening and closing device comprises:
a first rack extending in one direction inside the second door and installed to be reciprocally movable between a first position and a second position, spaced apart in the one direction, by receiving the driving force of the driving unit; and
a second rack connected to the first rack and the second magnet unit to transmit the driving force of the driving unit to the second magnet unit, and installed to be reciprocally movable inside the second door according to a change in position of the first rack,
the second hinge comprises:
a third rack comprising the locking hook and mounted on the hinge coupling portion to be movable according to a change in position of the second rack;
a third magnet unit coupled to the third rack to be movable by a magnetic force acting on the second magnet unit; and
a spring elastically supporting the third magnet unit.

5. The refrigerator of claim 4, wherein the second door is open by a repulsive force between the first magnet unit and the second magnet unit when a distance between centers of the first magnet unit and the second magnet unit is smaller than or equal to a first reference distance according to the movement of the first rack to the second position, and
the second door is closed by an attractive force between the first magnet unit and the second magnet unit when the distance between the centers of the first magnet unit and the second magnet unit is greater than or equal to the first reference distance according to the movement of the first rack to the first position.

6. The refrigerator of claim 1, further comprising:
a sensor unit configured to detect an open angle of the second door; and
a control unit configured to control the door opening and closing device according to a detection signal of the sensor unit,
wherein the control unit receives the detection signal from the sensor unit and closes the second door when the open angle of the second door is smaller than or equal to a reference angle.

7. The refrigerator of claim 4, wherein the second door further comprises a locking device configured to allow the first door and the second door to be locked or unlocked in a state where the second door is closed, and
the locking device comprises:
a latch bar installed inside the second door to be rotatable around a hinge pin; and
a latch hook arranged on one side of the latch bar to be locked to or unlocked from a locking wall, formed on the first door, according to rotation of the latch bar.

8. The refrigerator of claim 7, wherein the locking device further comprises a rotary bar coupled to another side of the latch bar to be rotatable around the hinge pin in an opposite direction to the latch hook, and extending in one direction from the another side of the latch bar toward the door opening and closing device,
the door opening and closing device comprises a cam arranged on one end of the first rack to face the rotary bar, and configured to convert a linear motion of the first rack into a rotational motion of the rotary bar,
the cam comprises:
a first contact surface formed to be in contact with one end of the rotary bar and inclined in a direction crossing an extension direction of the rotary bar; and
a second contact surface extending from the first contact surface in a direction away from the rotary bar, and accommodating the one end of the rotary bar, and
the one end of the rotary bar is formed in a hemispherical shape.

9. The refrigerator of claim 4, wherein the driving unit comprises a motor rotatable in both directions,
the first rack moves to the second position according to rotation of the motor in one direction when the second door is open, and
the first rack moves to the first position according to rotation of the motor in an opposite direction when the second door is closed.

10. The refrigerator of claim 9, wherein the door opening and closing device comprises:
a first gear connected to the motor;
a second gear engaging with the first gear at a preset gear ratio; and
a rack gear formed on one surface of the first rack toward the second gear to engage with the second gear.

11. The refrigerator of claim 4, wherein the door opening and closing device comprises:
an operating protrusion protruding from one surface of the first rack toward the second rack; and
a first contact protrusion and a second contact protrusion arranged spaced apart from each other in an extension direction of the first rack with the operating protrusion in between, and protruding from one surface of the second rack toward the one surface of the first rack, and
the operating protrusion is selectively in contact with one of the first contact protrusion and the second contact protrusion according to the change in position of the first rack, so that the driving force of the driving unit is transmitted from the first rack to the second rack.

12. The refrigerator of claim 3, wherein the second door is arranged in an opposite direction to the storage chamber based on the first door,
the first magnet unit comprises:
a first magnet arranged toward the storage chamber and having a first pole; and
a second magnet connected to one side surface of the first magnet in the opposite direction to the storage chamber and having a second pole opposite to the first pole,
the second magnet unit comprises:
a third magnet arranged toward the second magnet and having the second pole; and
a fourth magnet connected to one side surface of the third magnet in an opposite direction to the second magnet and having the first pole,
the second door is open by a repulsive force between the second magnet and the third magnet when a distance between centers of the second magnet and the third magnet is smaller than or equal to a first reference distance,
the second door is closed by an attractive force between the first magnet and the third magnet or an attractive force between the second magnet and the fourth magnet when the distance between the centers of the second magnet and the third magnet is greater than or equal to the first reference distance, and
the first pole is an S-pole and the second pole is an N-pole.

13. The refrigerator of claim 4, wherein the hinge coupling portion comprises:
a mounting portion on which the third rack is slidably mounted;
a first step formed in a step manner at one end of the mounting portion; and
a second step formed in a step manner at another end of the mounting portion, and
the third rack comprises a first slide coupled to the mounting portion to be reciprocally movable between the first step and the second step along the mounting portion.

14. The refrigerator of claim 13, wherein the third rack comprises a second slide extending from the first slide in a height direction of the second door, and
the third magnet unit is coupled to the second slide and arranged to face the second magnet unit in the one direction.

15. The refrigerator of claim 4, wherein the third magnet unit comprises a fifth magnet having a same pole as the second magnet unit.

16. The refrigerator of claim 15, wherein the spring is formed in a coil shape,
the third magnet unit comprises a magnet holder accommodating the fifth magnet,
the magnet holder comprises:
a first side wall arranged toward the second magnet unit; and
a second side wall arranged to face the first side wall in the one direction and supporting the fifth magnet together with the first side wall,
one end of the spring is supported on the second side wall, and
another end of the spring is supported on a spring support portion formed to be recessed toward the hinge shaft inside the second door.

17. The refrigerator of claim 14, wherein a side guide protrusion extends in a direction parallel to the hinge coupling portion inside the second door, and
the third rack comprises a side guide groove formed to be recessed into one surface of the second slide so that the side guide protrusion is coupled, the third rack moving along the side guide protrusion.

18. The refrigerator of claim 13, wherein the locking hook comprises:
a first hook portion protruding from the first slide to engage with the engaging protrusion;
a second hook portion arranged to overlap one surface of the first slide in a direction of gravity and supported on the one surface of the first slide; and
a hook connecting portion connected to the first hook portion and the second hook portion.

19. The refrigerator of claim 18, wherein the first hook portion comprises:
a first wall protruding in a first direction parallel to an extension direction of the hinge coupling portion and coupled to be in close contact with one surface of the engaging protrusion in a second direction crossing the first direction when the second door is closed;
a second wall spaced apart from the first wall in the second direction; and
a connecting wall connected to the first wall and the second wall, and
the connecting wall and the hinge coupling portion are arranged to overlap each other in the direction of gravity.

20. The refrigerator of claim 19, wherein the one surface of the engaging protrusion and the first wall of the first hook portion, which are in close contact with each other when the second door is closed, are each formed in a flat shape,
the first hook portion comprises a third wall arranged toward the hinge base and connecting one end of the first wall and one end of the second wall, wherein the third wall of the first hook portion and another surface of the engaging protrusion, which face in opposite directions along the first direction when the second door is closed, are each formed in a curved shape.
